(19) United States
(12) Patent Application Publication
(10) Pub. No.: US 2026/0204925 A1
(43) Pub. Date: Jul. 16, 2026

(54) REGENERATIVE POWER UTILIZATION SYSTEM, CONTROL METHOD, AND PROGRAM

(71) Applicant: Panasonic Intellectual Property Management Co., Ltd., Osaka (JP)

(72) Inventors: Ryo KAJITANI, Osaka (JP); Hiroshi YAMAMOTO, Osaka (JP)

(21) Appl. No.: 19/137,550

(22) PCT Filed: Oct. 6, 2023
(86) PCT No.: PCT/JP2023/036486

§ 371 Date: Jun. 10, 2025

(30) Foreign Application Priority Data
Dec. 26, 2022 (JP) 2022-208753

(51) Int. Cl. H02J 7/14; H02J 7/00

(52) U.S. Cl. CPC H02J 7/143; H02J 7/855; H02J 2207/20; H02J 2207/50

(57) ABSTRACT

At least two types of motor systems include: a first motor system including one or more first motors; and a second motor system including one or more second motors having a higher voltage specification than one or more first motors. A regenerative power utilization system includes a power converter circuit of a voltage step up/down type, an electrical storage device, and a control unit. Power converter circuit is connected between a first bus line and a second bus line and performs a switching operation on a plurality of switch elements. Electrical storage device is connected to power converter circuit. Control unit controls plurality of switch elements to charge electrical storage device with regenerative power. Control unit controls plurality of switch elements such that electrical energy stored in electrical storage device is used as electrical energy for powering first motor system when a particular condition is satisfied.

### TECHNICAL FIELD

The present disclosure generally relates to a regenerative power utilization system, a control method, and a program. More particularly, the present disclosure relates to a regenerative power utilization system, a control method, and a program, all of which are designed to utilize regenerative power generated by a motor.

### BACKGROUND ART

Patent Literature 1 discloses a multi-axis drive system for use to drive a plurality of motors on an individual basis. In this multi-axis drive system, when a control unit gives a power assist instruction to an inverter circuit, the inverter circuit stores an increase in bus line voltage in a bus line voltage smoothing capacitor in order to utilize regenerative power effectively. According to Patent Literature 1, part of the known bus line voltage smoothing capacitor in the multi-axis drive system is used as an electrical storage device for storing the regenerative power, thus achieving the advantage of eliminating the need to provide an additional electrical storage device.

### CITATION LIST

### Patent Literature

Patent Literature 1: WO 2014-167648 A1

### SUMMARY OF INVENTION

As for the regenerative power generated by a motor system including a motor with a relatively low voltage specification (of 48 V, for example), the electrical energy generated by a single motor is too small to be easily utilized with good efficiency, and therefore, is discarded inside the motor system in practice. Nevertheless, the larger the number of motors included in a motor system is, the more significantly the regenerative power to discard increases. Thus, a large-scale system should be able to utilize such regenerative power.

In view of the foregoing background, it is therefore an object of the present disclosure to provide a regenerative power utilization system, a control method, and a program, all of which contribute to achieving improvement on the utilization of regenerative power.

A regenerative power utilization system according to an aspect of the present disclosure is configured to utilize regenerative power generated by at least two types of motor systems. The at least two types of motor systems include: a first motor system including one or more first motors; and a second motor system including one or more second motors having a higher voltage specification than the one or more first motors. The regenerative power utilization system includes a power converter circuit of a voltage step up/down type, an electrical storage device, and a control unit. The power converter circuit is connected between a first bus line to supply electrical power to the first motor system and a second bus line to supply electrical power to the second motor system. The power converter circuit includes a plurality of switch elements and performs a switching operation on the plurality of switch elements. The electrical storage device is connected to the power converter circuit either between one side and the power converter circuit, or between the other side and the power converter circuit. The one side includes the first bus line. The other side includes the second bus line. The control unit controls the plurality of switch elements to charge the electrical storage device with the regenerative power. The control unit controls the plurality of switch elements such that electrical energy stored in the electrical storage device is used as electrical energy for powering the first motor system when a particular condition is satisfied.

A control method according to another aspect of the present disclosure is designed to utilize regenerative power generated by at least two types of motor systems. The at least two types of motor systems include: a first motor system including one or more first motors; and a second motor system including one or more second motors having a higher voltage specification than the one or more first motors. The control method includes a first control step and a second control step. The first control step includes controlling a plurality of switch elements in a power converter circuit of a voltage step up/down type to charge an electrical storage device with the regenerative power. The power converter circuit includes the plurality of switch elements and performs a switching operation on the plurality of switch elements. The power converter circuit is connected between a first bus line to supply electrical power to the first motor system and a second bus line to supply electrical power to the second motor system. The electrical storage device is connected to the power converter circuit either between one side and the power converter circuit, or between the other side and the power converter circuit. The one side includes the first bus line. The other side includes the second bus line. The second control step includes controlling the plurality of switch elements such that electrical energy stored in the electrical storage device is used as electrical energy for powering the first motor system when a particular condition is satisfied.

A program according to still another aspect of the present disclosure is designed to cause one or more processors to perform the control method described above.

### BRIEF DESCRIPTION OF DRAWINGS

FIG. 1A is a circuit diagram of an overall system including a regenerative power utilization system according to an exemplary embodiment; FIG. 1B is a block diagram illustrating a configuration for a control unit included in the regenerative power utilization system;

FIG. 2 is a flowchart illustrating how the regenerative power utilization system performs an operation concerning determination of a control mode;

FIG. 3 is a flowchart illustrating how the regenerative power utilization system performs an operation concerning a charging mode;

FIG. 4 is a flowchart illustrating how the regenerative power utilization system performs an operation concerning a discharging mode;

FIG. 5 is a circuit diagram illustrating a first variation of the regenerative power utilization system;

FIG. 6 is a schematic circuit diagram of an overall system including a second variation of the regenerative power utilization system; and

FIG. 7 is a schematic circuit diagram of an overall system including a third variation of the regenerative power utilization system.

### DESCRIPTION OF EMBODIMENTS

### Overview

An exemplary embodiment of a regenerative power utilization system and its variations will be described with reference to the accompanying drawings. Note that the embodiment and its variations to be described below are only an exemplary one of various embodiments of the present disclosure and its variations and should not be construed as limiting. Rather, the exemplary embodiment and its variations may be readily modified in various manners depending on a design choice or any other factor without departing from the scope of the present disclosure. Optionally, the variations to be described later may be adopted in combination as appropriate.

The drawings to be referred to in the following description of embodiments and their variations are all schematic representations. Thus, the ratio of the dimensions (including thicknesses) of respective constituent elements illustrated on the drawings does not always reflect their actual dimensional ratio.

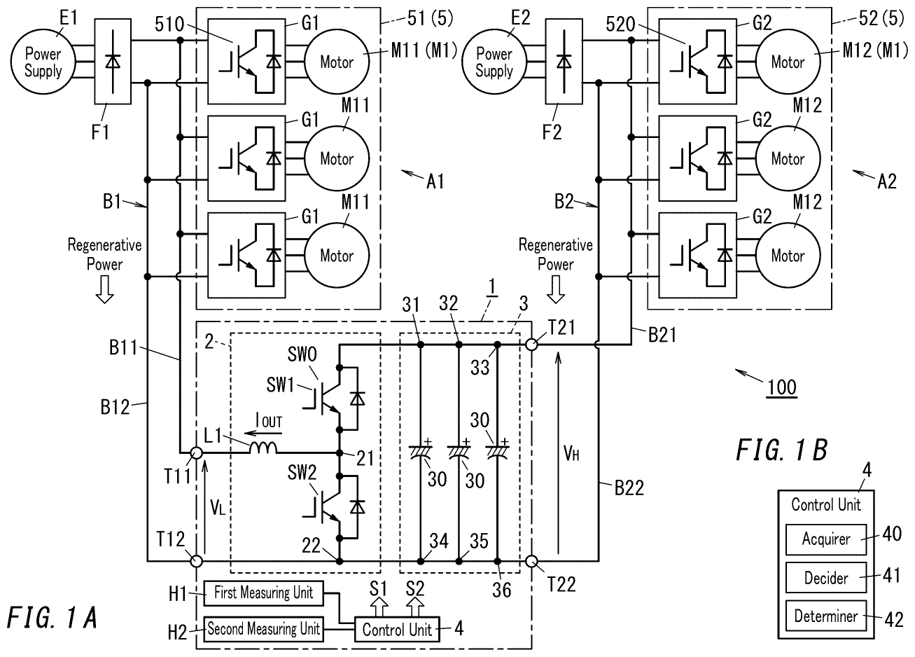

As shown in FIG. 1A, a regenerative power utilization system 1 according to an aspect is configured to utilize regenerative power generated by at least two types of motor systems 5. The at least two types of motor systems 5 include: a first motor system 51 including one or more (e.g., three in FIG. 1A) first motors M11; and a second motor system 52 including one or more (e.g., three in FIG. 1A) second motors M12. Note that the one or more second motors M12 have a higher voltage specification than the one or more first motors M11. In the exemplary embodiment to be described below, the regenerative power utilization system 1 is applied to the first motor system 51 and the second motor system 52 and configured to utilize the regenerative power generated by these motor systems 5 as an example. Nevertheless, the number of motor systems 5 to which the regenerative power utilization system 1 is applied is not limited to any particular number. In addition, the number of motors included in each motor system 5 is not limited to any particular number, either. The number of the first motors M11 provided is the same (e.g., three) as the number of the second motors M12 provided in the example shown in FIG. 1A but does not have to be the same as the latter number. In the following description, if there is no need to distinguish the first motors M11 from the second motors M12, the first motors M11 and the second motors M12 will be hereinafter collectively referred to as “motors M1.”

Each motor M1 may be, for example, a servo motor. Each motor M1 may be a rotary motor, for example, but may also be a linear motor. Each motor M1 includes a stator around which three-phase (namely, U-, V-, and W-phases) windings are wound, for example. Each motor system 5 is configured to make driving control of the operation (rotating operation) of the motor M1. For example, the rated voltage (voltage specification) of the first motors M11 is 48 V and the rated voltage (voltage specification) of the second motors M12 is 100 V. That is to say, the voltage specification of the second motors M12 is higher than the voltage specification of the first motors M11. Nevertheless, the specification of the motor M1 itself is not limited to any particular one. For example, the motor M1 may be a motor that does not require a servo amplifier. Alternatively, the motor M1 may be a brushless motor or a brush motor. In addition, the motor M1 may be an AC motor or a DC motor, whichever is appropriate.

As shown in FIG. 1A, the regenerative power utilization system 1 includes a power converter circuit 2 of a voltage step up/down type, an electrical storage device 3, and a control unit 4. The power converter circuit 2 is connected between a first bus line B1 to supply electrical power to the first motor system 51 and a second bus line B2 to supply electrical power to the second motor system 52. The power converter circuit 2 includes a plurality of switch elements SW0 and performs a switching operation on the plurality of switch elements SW0 (e.g., two switch elements (namely, a first switch element SW1 and a second switch element SW2) in the example shown in FIG. 1A).

The electrical storage device 3 is connected to the power converter circuit 2 either between one side including the first bus line B1 and the power converter circuit 2, or between the other side including the second bus line B2 and the power converter circuit 2. The control unit 4 controls the plurality of switch elements SW0 to charge the electrical storage device 3 with the regenerative power. In the exemplary embodiment to be described below, the electrical storage device 3 is connected to the power converter circuit 2 on the other side including the second bus line B2 as an example. The control unit 4 controls the plurality of switch elements SW0 such that electrical energy stored in the electrical storage device 3 is used as electrical energy for powering the first motor system 51 when a particular condition is satisfied. As used herein, the “particular condition” includes, for example, the condition that the quantity of the powering energy generated be equal to or greater than the quantity of the regenerative power generated on the first bus line B1 and the quantity of the regenerative power generated be greater than the quantity of the powering energy generated on the second bus line B2.

This regenerative power utilization system 1 allows the electrical storage device 3 to be charged with the regenerative power generated by the first motor system 51 and the second motor system 52, of which the motors M1 have mutually different voltage specifications. In addition, the electrical energy stored in the electrical storage device 3 is used as electrical energy for powering the first motor system 51. Consequently, this regenerative power utilization system 1 achieves the advantage of contributing to improvement on the utilization of regenerative power.

A control method according to another aspect is applicable to the utilization of regenerative power generated by at least two types of motor systems 5. The control method includes a first control step and a second control step. The first control step includes controlling a plurality of switch elements SW0 in the power converter circuit 2 of a voltage step up/down type to charge the electrical storage device 3 with the regenerative power. The second control step includes controlling the plurality of switch elements SW0 such that electrical energy stored in the electrical storage device 3 is used as electrical energy for powering the first motor system 51 when a particular condition is satisfied. This allows for providing a control method contributing to improvement on the utilization of regenerative power. This control method is used on a computer system (i.e., the control unit 4 of the regenerative power utilization system 1). That is to say, this control method is also implementable as a program. A program according to still another aspect is designed to cause one or more processors to perform the control method described above.

### Details

Next, an overall system (motor management system 100) including the regenerative power utilization system 1 according to this embodiment and its peripheral circuit components will be described in detail with reference to FIGS. 1A and 1B.

The motor management system 100 may be introduced into a facility such as a factory. As used herein, the peripheral circuit components of the motor management system 100 include a first configuration group A1 provided for the first motor system 51 and a second configuration group A2 provided for the second motor system 52 as shown in FIG. 1A.

The first configuration group A1 includes a power supply E1 (such as a commercial AC power supply), a rectifier F1, the first bus line B1, one or more (e.g., three in this example) first motors M11 (servo motors), and a plurality of (i.e., three in total in FIG. 1A) power conversion units G1 respectively provided for the first motors M11. Each power conversion unit G1 may be provided inside a servo amplifier, for example. The three first motors M11 and the three power conversion units G1 are constituent elements of the first motor system 51. The first motor system 51 further includes a number of revolutions detector for detecting the number of revolutions of each first motor M11 and a motor driver for driving the first motors M11 by controlling the power conversion units G1. In short, the first motor system 51 is configured to make drive control of the operation (e.g., the rotating operation in this example) of each first motor M11. Optionally, the first configuration group A1 may further include a high-order controller and a user interface (such as a display monitor and an operating device) for use to enter various settings and monitor the operation.

The second configuration group A2 includes a power supply E2 (such as a commercial AC power supply), a rectifier F2, the second bus line B2, one or more (e.g., three in this example) second motors M12 (servo motors), and a plurality of (i.e., three in total in FIG. 1A) power conversion units G2 respectively provided for the second motors M12. Each power conversion unit G2 may be provided inside a servo amplifier, for example. The three second motors M12 and the three power conversion units G2 are constituent elements of the second motor system 52. The second motor system 52 further includes a number of revolutions detector for detecting the number of revolutions of each second motor M12 and a motor driver for driving the second motors M12 by controlling the power conversion units G2. In short, the second motor system 52 is configured to make drive control of the operation (e.g., the rotating operation in this example) of each second motor M12. Optionally, the second configuration group A2 may further include a high-order controller and a user interface (such as a display monitor and an operating device) for use to enter various settings and monitor the operation. Note that the high-order controller of the first configuration group A1 and the high-order controller of the second configuration group A2 may be implemented as a single high-order controller.

The plurality of motors M1 included in the first configuration group A1 and the configuration group A2 are rotary motors, as described above. Optionally, the plurality of motors M1 may include a linear motor. Each motor M1 has an output shaft and rotates its output shaft under the control of the motor driver. Each motor M1 forms, along with a mechanical mechanism, a drive system. The mechanical mechanism may be, without limitation, a ball screw mechanism, a gear mechanism, or a belt mechanism, for example. The mechanical mechanism is coupled to the output shaft of the motor M1. The mechanical mechanism is supplied with motive power by the motor M1. For example, if some of the plurality of motors M1 are applied to a carrier such as a belt conveyor in a facility such as a factory, rotation of the output shaft of the motor M1 causes a belt to turn via the mechanical mechanism, thereby sequentially automatically carrying a plurality of products or components mounted on the belt. In addition, some of the plurality of motors M1 are also applicable to, for example, robot arms provided inside the facility such as a factory.

Each motor M1 may be, for example, a three-phase brushless motor and has a stator, in which three-phase windings are wound. Specifically, the motor M1 includes a stator, in which winding wires of respective phases, namely, U-, V-, and W-phases, are wound around a stator core, and a rotor including permanent magnets. The motor M1 further includes first, second, and third terminals respectively corresponding to three-phase input terminals. Applying drive voltages generated by the power conversion units G1 or G2 under the control of the motor driver to the first to third terminals, respectively, causes a drive current to flow, thus rotating the rotor.

The voltage specification of the second motors M12 is higher than the voltage specification of the first motors M11. The rated voltage (voltage specification) of the first motors M11 may be, for example, 48 V. The rated voltage (voltage specification) of the second motors M12 may be, for example, 100 V. The first motors M11 are connected to a 48 V system in the first motor system 51. The first motor system 51 is connected to the first bus line B1 with a rated voltage of DC 48 V. The second motors M12 are connected to a 100 V system in the second motor system 52. The second motor system 52 is connected to the second bus line B2 with a rated voltage of DC 100 V.

Note that the numerical values about the voltage specifications and their combinations are only examples. Alternatively, the rated voltage of the first motors M11 may be 48V and the rated voltage of the second motors M12 may be 200 V, for example. In that case, the first motor system 51 may be connected to the first bus line B1 with a rated voltage of DC 48V and the second motor system 52 may be connected to the second bus line B2 with a rated voltage of DC 200 V. Still alternatively, the first motors M11 may have a rated voltage of 100 V and the second motors M12 may have a rated voltage of 200 V, for example. In that case, the first motor system 51 may be connected to the first bus line B1 with a rated voltage of DC 100 V and the second motor system 52 may be connected to the second bus line B2 with a rated voltage of DC 200 V. In particular, these numerical values about the voltage specifications may vary from one country to another (including the country of Japan), and therefore, may be changed as appropriate.

The number of revolutions detector included in each of the motors in the first configuration group A1 and the configuration group A2 may be implemented as, for example, an encoder to detect the number of revolutions (in other words, the rotational velocity) of the corresponding motor M1 based on the rotational position of the motor M1. The number of revolutions detector is electrically connected to the motor driver. The number of revolutions detector outputs a detection signal (electrical signal) including a detected value to the motor driver. The motor driver controls the operation of the motor M1 to perform a predetermined type of operations (such as carrying operations) in accordance with the detection signal supplied from the number of revolutions detector and a control signal supplied from the high-order controller.

Each of the high-order controllers included in the first configuration group A1 and the configuration group A2 may be implemented using, for example, a programmable logic controller and controls the motor driver by giving, for example, an operating command thereto. The high-order controller and the motor driver are connected to be ready to communicate with each other via a control bus line, for example, so that an operating command supplied from the high-order controller is transmitted to the motor driver and information provided by the motor driver is transmitted to the high-order controller.

The rectifier F1 included in the first configuration group A1 rectifies the AC power supplied from the power supply E1 to convert the AC power into DC power and output the DC power to the three power conversion units G1 of the first motor system 51 via the first bus line B1. Specifically, the first bus line B1 includes a first electrical path B11 on a higher potential side and a second electrical path B12 on a lower potential side. A higher-potential-side output terminal, which is one of the pair of output terminals of the rectifier F1, is electrically connected to a higher-potential-side input terminal, which is one of the pair of input terminals of each of the power conversion units G1, via the first electrical path B11 of the first bus line B1. On the other hand, a lower-potential-side output terminal, which is the other one of the pair of output terminals of the rectifier F1, is electrically connected to a lower-potential-side input terminal, which is the other one of the pair of input terminals of each of the power conversion units G1, via the second electrical path B12 of the first bus line B1. In short, the first bus line B1 is a bus line configured to supply DC power to the first motor system 51. Note that the first electrical path B11 on the higher potential side is also electrically connected to a first input/output terminal T11 of the regenerative power utilization system 1 (to be described later) and the second electrical path B12 on the lower potential side is also electrically connected to a second input/output terminal T12 of the regenerative power utilization system 1 (to be described later).

Each of the power conversion units G1 includes an inverter unit. The DC power is supplied from the rectifier F1 to the inverter unit. The inverter unit of each power conversion unit G1 includes a plurality of semiconductor switching elements 510 (only one of which is shown in FIG. 1A) that performs a switching operation. Specifically, the inverter unit includes insulated gate bipolar transistors (IGBTs) as the semiconductor switching elements 510. Alternatively, the semiconductor switching elements 510 may also be metal-oxide semiconductor field effect transistors (MOSFETs). In the inverter unit, the plurality of semiconductor switching elements 510 thereof are subjected to PWM control in accordance with a pulse width modulation (PWM) signal supplied from the processing unit of the motor driver. As a result, the DC power is converted into AC power in three phases consisting of U-, V-, and W-phases. Each power conversion unit G1 drives a corresponding one of the first motors M11 by supplying the three-phase AC power thus converted to the first motor M11. Note that the regenerative power generated by each of the first motors M11 may be output onto the first bus line B1 via the power conversion unit G1 to be supplied to the regenerative power utilization system 1.

The rectifier F2 included in the second configuration group A2 rectifies the AC power supplied from the power supply E2 to convert the AC power into DC power and output the DC power to the three power conversion units G2 of the second motor system 52 via the second bus line B2. Specifically, the second bus line B2 includes a first electrical path B21 on a higher potential side and a second electrical path B22 on a lower potential side. A higher-potential-side output terminal, which is one of the pair of output terminals of the rectifier F2, is electrically connected to a higher-potential-side input terminal, which is one of the pair of input terminals of each of the power conversion units G2, via the first electrical path B21 of the second bus line B2. On the other hand, a lower-potential-side output terminal, which is the other one of the pair of output terminals of the rectifier F2, is electrically connected to a lower-potential-side input terminal, which is the other one of the pair of input terminals of each of the power conversion units G2, via the second electrical path B22 of the second bus line B2. In short, the second bus line B2 is a bus line configured to supply DC power to the second motor system 52. Note that the first electrical path B21 on the higher potential side is also electrically connected to a first input/output terminal T21 of the regenerative power utilization system 1 (to be described later) and the second electrical path B22 on the lower potential side is also electrically connected to a second input/output terminal T22 of the regenerative power utilization system 1 (to be described later).

Each of the power conversion units G2 includes an inverter unit. The DC power is supplied from the rectifier F2 to the inverter unit. The inverter unit of each power conversion unit G2 includes a plurality of semiconductor switching elements 520 (only one of which is shown in FIG. 1A) that performs a switching operation. Specifically, the inverter unit includes IGBTs as the semiconductor switching elements 520. Alternatively, the semiconductor switching elements 510 may also be MOSFETs. In the inverter unit, the plurality of semiconductor switching elements 520 thereof are subjected to PWM control in accordance with a PWM signal supplied from the processing unit of the motor driver. As a result, the DC power is converted into AC power in three phases consisting of U-, V-, and W-phases. Each power conversion unit G2 drives a corresponding one of the second motors M12 by supplying the three-phase AC power thus converted to the second motor M12. Note that the regenerative power generated by each of the second motors M12 may be output onto the second bus line B2 via the power conversion unit G2 to be supplied to the regenerative power utilization system 1.

The regenerative power utilization system 1 is configured to utilize the regenerative power generated by the at least two types of motor systems 5. In this embodiment, the regenerative power utilization system 1 is configured to utilize, for example, the regenerative power generated by the first motor system 51 and the second motor system 52 as described above.

The regenerative power utilization system 1 includes a power converter circuit 2 of a voltage step up/down type, an electrical storage device 3, and a control unit 4. The regenerative power utilization system 1 further includes a pair of input/output terminals (namely, a first input/output terminal T11 and a second input/output terminal T12) connected to the one side including the first bus line B1 and a pair of input/output terminals (namely, a first input/output terminal T21 and a second input/output terminal T22) connected to the other side including the second bus line B2. In addition, the regenerative power utilization system 1 further includes a first measuring unit H1 and a second measuring unit H2.

The regenerative power utilization system 1 is supposed to be implemented as, for example, a single device in which the power converter circuit 2, the electrical storage device 3, the control unit 4, the first measuring unit H1, and the second measuring unit H2 are housed in a single housing. However, this is only an example and should not be construed as limiting. Alternatively, the regenerative power utilization system 1 may also be implemented as a plurality of devices which are electrically connectible to each other. In that case, the power converter circuit 2, the electrical storage device 3, the control unit 4, the first measuring unit H1, and the second measuring unit H2 may be housed to be distributed in a plurality of housings of a plurality of devices.

The power converter circuit 2 is implemented as a bidirectional DC/DC converter circuit. The power converter circuit 2 is connected between the first bus line B1 and the second bus line B2. The power converter circuit 2 may include, for example, a plurality of switch elements SW0 (e.g., two semiconductor switching elements consisting of a first switch element SW1 and a second switch element SW2 in this example) and an inductor L1. In the following description, when the two switch elements SW0 need to be distinguished from each other, the two switch elements SW0 will be hereinafter referred to as a “first switch element SW1” and a “second switch element SW2,” respectively. On the other hand, if there is no need to distinguish the first switch element SW1 and the second switch element SW2 from each other, the first switch element SW1 and the second switch element SW2 will be hereinafter simply collectively referred to as “switch elements SW0.” The inductor L1 has a first terminal and a second terminal. The first terminal of the inductor L1 is electrically connected to the first input/output terminal T11 which is connected to the first electrical path B11 on the higher potential side of the first bus line B1. The second terminal of the inductor L1 is electrically connected to a connection node 21.

Each of the first switch element SW1 and the second switch element SW2 includes a control terminal, a first main terminal, and a second main terminal. Each switch element SW0 may be implemented as, for example, an IGBT. Thus, the control terminal, first main terminal, and second main terminal of each switch element SW0 may be a gate terminal, a collector terminal, and an emitter terminal, respectively. However, this is only an example and should not be construed as limiting. Each switch element SW0 does not have to be an IGBT but may also be, for example, a MOSFET, a bipolar transistor, or a GaN-based transistor.

The control terminal of each switch element SW0 is electrically connected to the control unit 4. The first main terminal of the first switch element SW1 is electrically connected to a higher-potential-side terminal of the electrical storage device 3. The second main terminal of the first switch element SW1 is electrically connected to the first main terminal of the second switch element SW2 via the connection node 21. The second main terminal of the second switch element SW2 is electrically connected to a connection node 22. Note that the connection node 22 is electrically connected to the second input/output terminal T12 which is connected to the second electrical path B12 on the lower potential side of the first bus line B1. The connection node 22 is also electrically connected to the lower-potential-side terminal of the electrical storage device 3.

The power converter circuit 2 performs a switching operation on the two switch elements SW0. That is to say, the first switch element SW1 and the second switch element SW2 are controlled by the control unit 4 to turn ON and OFF. In short, the power converter circuit 2 is a 48 V/100 V converter circuit.

The electrical storage device 3 includes a plurality of (e.g., three in the example shown in FIG. 1A) electrolytic capacitors 30. In this embodiment, the electrical storage device 3 may be connected to the power converter circuit 2, for example, between the other side including the second bus line B2 and the power converter circuit 2. The three electrolytic capacitors 30 are connected to each other in parallel. Each of the three electrolytic capacitors 30 has a first terminal and a second terminal. The electrical storage device 3 is supposed to include a plurality of electrolytic capacitors 30, each having a breakdown voltage of 200 V.

The first terminals of the three electrolytic capacitors 30 are electrically connected to connection nodes 31, 32, 33 (on the higher potential side), respectively. Note that the connection node 31 is electrically connected to the first main terminal of the first switch element SW1. The connection node 33 is electrically connected to the first input/output terminal T21 which is connected to the first electrical path B21 on the higher potential side of the second bus line B2.

The second terminals of the three electrolytic capacitors 30 are electrically connected to connection nodes 34, 35, 36 (on the lower potential side), respectively. Note that the connection node 34 is electrically connected to the connection node 22. The connection node 36 is electrically connected to the second input/output terminal T22 which is connected to the second electrical path B22 on the lower potential side of the second bus line B2.

The electrical storage device 3 according to the present disclosure is not limited to any particular type. The electrical storage device 3 may be implemented as, for example, a film capacitor, an electrical double layer capacitor (capacitor) or a lithium-ion capacitor. Nevertheless, the electrical storage device 3 preferably satisfies the breakdown voltage condition according to the voltage specification on the other side including the second bus line B2. In this respect, the electrical storage device 3 is preferably implemented as electrolytic capacitors 30, which are unlikely to have an oversize, have a high breakdown voltage, and reduce the chances of making the control complicated, as is done in this embodiment. Conversely, the electrical storage device 3 may be connected to the power converter circuit 2 between one side including the first bus line B1 and the power converter circuit 2. In that case, the electrical storage device 3 may be implemented as a device with a relatively low breakdown voltage.

The agent that performs the functions of the control unit 4 includes a computer system including one or more processors and a memory. At least some functions of the control unit 4 are performed by making the processor of the computer system execute a program stored in the memory of the computer system. The program may be stored in the memory. Alternatively, the program may also be downloaded via a telecommunications line such as the Internet or distributed after having been stored in a non-transitory storage medium such as a memory card.

The control unit 4 controls the first switch element SW1 and the second switch element SW2 of the power converter circuit 2 to charge the electrical storage device 3 with the regenerative power generated by the first motor system 51 and the second motor system 52. In addition, the control unit 4 also controls the first switch element SW1 and the second switch element SW2 to use the electrical energy stored in the electrical storage device 3 as electrical energy for powering the first motor system 51 when a particular condition is satisfied. Note that in this embodiment, the electrical energy stored in the electrical storage device 3 is also supposed to be used as electrical energy for powering the second motor system 52 and may be used as electrical energy for powering the second motor system 52 when a condition is satisfied.

The control unit 4 generates control signals S1 and S2 for controlling the ON/OFF states of the first switch element SW1 and the second switch element SW2 and outputs the control signals S1 and S2 to the respective control terminals (gate terminals) of the first switch element SW1 and the second switch element SW2. Each of the control signals S1 and S2 may be, for example, a PWM signal having a potential level that alternates between a first potential level (hereinafter referred to as a “low level”) and a second potential level (hereinafter referred to as a “high level”) higher than the first potential level. The first switch element SW1 turns ON when the control signal S1 has high level and turns OFF when the control signal S1 has low level. In the same way, the second switch element SW2 turns ON when the control signal S2 has high level and turns OFF when the control signal S2 has low level.

The control unit 4 performs switching control on the first switch element SW1 and the second switch element SW2 to make the output voltage of the power converter circuit 2 closer toward a target value by adjusting the respective duties of the control signals S1 and S2.

In this embodiment, the control unit 4 controls the first switch element SW1 and the second switch element SW2 to charge the electrical storage device 3 with electricity by stepping up the voltage of the regenerative power generated by the first motor system 51 (which is charging control as a first control step). The control unit 4 also controls the first switch element SW1 and the second switch element SW2 by stepping down the voltage of the electrical energy stored in the electrical storage device 3 to use the electrical energy as electrical energy for powering the first motor system 51 (which is discharging control as a second control step).

Specifically, the control unit 4 includes an acquirer 40, a decider 41, and a determiner 42 as shown in FIG. 1B. In other words, the control unit 4 performs the respective functions of the acquirer 40, the decider 41, and the determiner 42.

The acquirer 40 is configured to acquire information including a measured value as an electrical signal from each of the first measuring unit H1 and the second measuring unit H2. That is to say, the first measuring unit H1 and the second measuring unit H2 are electrically connected to the control unit 4. The first measuring unit H1 monitors (measures) the power balance on the one side including the first bus line B1 and outputs the result of the measurement (as a first measured value) to the control unit 4. The second measuring unit H2 monitors (measures) the power balance on the other side including the second bus line B2 and outputs the result of the measurement (as a second measured value) to the control unit 4. In this embodiment, the measured values (including the first measured value and the second measured value) are voltage values. The acquirer 40 acquires the first measured value and the second measured value.

The first measuring unit H1 may include, for example, a voltmeter arranged to measure (detect) the voltage V_{L} (refer to FIG. 1A) between the first input/output terminal T11 and the second input/output terminal T12 on the one side including the first bus line B1 and outputs the voltage value thus measured as a first measured value to the control unit 4. The second measuring unit H2 may include, for example, a voltmeter arranged to measure (detect) the voltage V_{H} (refer to FIG. 1A) between the first input/output terminal T21 and the second input/output terminal T22 on the other side including the second bus line B2 and outputs the voltage value thus measured as a second measured value to the control unit 4.

The measured value (e.g., a voltage value in this example) may be either an instantaneous value or the average value, maximum value, minimum value, median, or representative value of sampling data during a predetermined period, whichever is appropriate. The measured value does not have to be a voltage value. Alternatively, the measured value may also be a value about at least one of a current value, a voltage value, a current rise rate, or a voltage rise rate.

The decider 41 is configured to decide which of the powering energy generated or the regenerative power generated is larger in quantity in each of the one side including the first bus line B1 and the other side including the second bus line B2. That is to say, the decider 41 decides which of the powering energy generated or the regenerative power generated is larger in quantity on the one side including the first bus line B1. In addition, the decider 41 also decides which of the powering energy generated or the regenerative power generated is larger in quantity on the other side including the second bus line B2. In this embodiment, the decider 41 may decide, for example, by comparing the measured value (e.g., a voltage value in this example) with the reference value, which of the quantity of the powering energy generated or the quantity of the regenerative power generated prevails over the other as for the current power balance on each bus line. The determiner 42 determines, based on the decision made by the decider 41, which of a plurality of control modes is to be selected. The control unit 4 controls the plurality of switch elements SW0 in the control mode determined by the determiner 42. The plurality of control modes includes at least a voltage step-up control mode and a voltage step-down control mode. Such a configuration for determining the control mode based on the decision made by the decider 41 allows the power converter circuit 2 to be controlled more appropriately according to the respective states of the powering energy and the regenerative power on each of the one side including the first bus line B1 and the other side including the second bus line B2.

In the following description, the voltage step-up control mode will be hereinafter referred to as a “charging mode” and the voltage step-down control mode will be hereinafter referred to as a “discharging mode.” As will be described in detail later, in this embodiment, the plurality of control modes includes not only the voltage step-up control mode (charging mode) and the voltage step-down control mode (discharging mode) but also a standby mode, for example.

### [Charging Mode]

In this section, the charging mode according to the present disclosure will be described. First, in this embodiment, if regenerative power is generated on the other side including the second bus line B2, then the electrical storage device 3 is connected to the other side including the second bus line B2 such that the electrical storage device 3 is charged with electricity automatically without intervention of the control unit 4 into the control. Thus, the charging mode is a mode in which the voltage of the regenerative power generated on the one side including the first bus line B1 is stepped up and the electrical storage device 3 is charged with the electric power thus stepped up. In the charging mode, the control unit 4 controls the plurality of switch elements SW0 to step up the voltage of the regenerative power generated on the one side including the first bus line B1. Specifically, the control unit 4 sets the bus voltage on the other side including the second bus line B2, i.e., a voltage value higher than the current voltage value (i.e., a second measured value) of the voltage V_{H} between the first input/output terminal T21 and the second input/output terminal T22, as a target value. Setting such a target value causes the voltage on the other side including the second bus line B2 to rise to allow a current to flow in the direction opposite from the direction indicated by “Iout” in FIG. 1A. The control unit 4 generates a control signal, of which the duty corresponds to the target value (e.g., the difference between the target value and the latest measured value), and outputs the control signal to the control terminal of the second switch element SW2, thereby performing switching control on (i.e., controlling the ON/OFF states of) the second switch element SW2. In the charging mode, the control unit 4 performs control to keep the first switch element SW1 OFF or turn the first switch element SW1 OFF when the second switch element SW2 is ON and turn the first switch element SW1 ON when the second switch element SW2 is OFF. In short, in the charging mode, the control unit 4 performs constant voltage control with a target voltage value set with respect to the other side including the second bus line B2.

### [Discharging Mode]

In this section, the discharging mode according to the present disclosure will be described. First, in this embodiment, the electrical energy stored in the electrical storage device 3 is supposed to be used as the electrical energy for powering the second motor system 52 as well, as described above. In the following description, the discharging mode will be described as a mode in which electrical energy is discharged from the electrical storage device 3 with the voltage of the electrical energy discharged from the electrical storage device 3 stepped down such that the electrical energy thus stepped down may be used as the powering energy on the one side including the first bus line B1. In the discharging mode, the control unit 4 controls the plurality of switch elements SW0 to step down the voltage of the electrical energy discharged from the electrical storage device 3. Specifically, the control unit 4 sets a voltage value higher than the bus voltage on the one side including the first bus line B1, i.e., the current voltage value (i.e., a first measured value) of the voltage V_{L} between the first input/output terminal T11 and the second input/output terminal T12, as a target value. Setting such a target value causes the voltage on the one side including the first bus line B1 to rise to allow a current to flow in the direction indicated by “Iout” in FIG. 1A. The control unit 4 generates a control signal, of which the duty corresponds to the target value (e.g., the difference between the target value and the latest measured value), and outputs the control signal to the control terminal of the first switch element SW1, thereby performing switching control on (i.e., controlling the ON/OFF states of) the first switch element SW1. In the discharging mode, the control unit 4 performs control to keep the second switch element SW2 OFF or turn the second switch element SW2 OFF when the first switch element SW1 is ON and turn the second switch element SW2 ON when the first switch element SW1 is OFF. In short, in the discharging mode, the control unit 4 performs constant voltage control with a target voltage value set with respect to the one side including the first bus line B1.

Note that in this embodiment, the control unit 4 is supposed to perform the switching control with the ON-state ratio of the duty adjusted as needed to a value less than one, as an example. Alternatively, to shorten the time it takes to charge and discharge the electrical storage device 3, switching control may also be performed with the duty fixed at a preset value in each of the charging mode and the discharging mode.

As can be seen from the foregoing description, the control unit 4 sets, in accordance with the determination made by the determiner 42, a voltage value higher than the current voltage value as a target value with respect to either the first bus line B1 or the second bus line B2 through which a current supplied from the regenerative power utilization system 1 is allowed to flow. Then, the control unit 4 adjusts the duty related to the switching control of the plurality of switch elements SW0.

In the first motor system 51, for example, if the power conversion unit G1 is supplying electric power to one first motor M11 at a certain point in time to cause the first motor M11 to drive the load, the system including the motor M11 may be in the powering state. However, if another first motor M11 is decelerating, for example, at the same certain point in time, then the system of that motor M11 may be in the regenerative state in which the rotational energy of that first motor M11 flows into the side including the power conversion unit G1. Thus, the decider 41 decides, by using the measured value with respect to the current power balance in the overall first motor system 51, which of the quantity of the powering energy generated or the quantity of the regenerative power generated prevails over the other. In the same way, as for the second motor system 52, the decider 41 also decides, by using the measured value with respect to the current power balance in the overall second motor system 52, which of the quantity of the powering energy generated or the quantity of the regenerative power generated prevails over the other.

The decider 41 compares the measured value with respect to each of the first bus line B1 and the second bus line B2 with a predetermined reference value (standard voltage value). Information about the reference value is stored in advance in, for example, a memory of the control unit 4 or storage unit (e.g., an electrically programmable nonvolatile semiconductor memory such as a flash memory) provided separately from the memory. Note that the reference value (first reference value) to be compared with the measured value about the first bus line B1 is a value different from the reference value (second reference value) to be compared with the measured value about the second bus line B2. The reference value is preferably set to fall within a reference range having some width with a tolerable error.

Regarding each of the first bus line B1 and the second bus line B2, if the measured value about a corresponding bus line is greater than the reference value, then the decider 41 decides that the corresponding bus line be a regeneration prevalent state in which the quantity of the regenerative power generated is greater than the quantity of the powering energy generated. On the other hand, regarding each of the first bus line B1 and the second bus line B2, if the measured value about a corresponding bus line is equal to or less than the reference value, then the decider 41 decides that the corresponding bus line be a powering prevalent state in which the quantity of the regenerative power generated is less than the quantity of the powering energy generated.

As an example, the decision is supposed to be made by the sign of the differential value between the measured value and the reference value. For example, if the sign of the differential value of the measured value from the reference value is negative (−) or if the differential value is zero, then the decider 41 decides that this be the powering prevalent state. If the measured value falls within the reference range including the tolerable error, the differential value is regarded as zero. On the other hand, if the sign of the differential value of the measured value from the reference value is positive (+), then the decider 41 decides that this be the regeneration prevalent state.

Next, the control mode that the control unit 4 may select depending on whether the first bus line B1 is in the regeneration prevalent state or the powering prevalent state and whether the second bus line B2 is in the regeneration prevalent state or the powering prevalent state will be described separately with respect to three different Situations #1, #2, and #3.

### [Situation #1: Where One Bus Line is in Regeneration Prevalent State and the Other Bus Line is in Powering Prevalent State]

Suppose the decision made by the decider 41 indicates that one bus line out of the first bus line B1 and the second bus line B2 is in the regeneration prevalent state and the other bus line is in the powering prevalent state. In that case, the control unit 4 controls the plurality of switch elements SW0 to increase the voltage on the side, including the other bus line, of the one side and the other side, such that a current flows from the electrical storage device 3 toward the other bus line in the powering prevalent state.

Specifically, if the first bus line B1 is in the regeneration prevalent state and the second bus line B2 is in the powering prevalent state, then the determiner 42 selects (determines) the charging mode (voltage step-up control mode) as the control mode. In the charging mode, the control unit 4 performs switching control on the second switch element SW2 by turning the second switch element SW2 ON and OFF and performs control to keep the first switch element SW1 OFF, thereby stepping up the voltage of the regenerative power from the one side including the first bus line B1 to charge the electrical storage device 3 with the electric power thus stepped up. At this time, the control unit 4 sets a voltage value higher than the current voltage value (second measured value) of the voltage V_{H} between the first input/output terminal T21 and the second input/output terminal T22 as a target value as described above. Setting such a target value causes the control unit 4 to step up the voltage on the other side including the second bus line B2 to allow a current to flow from the electrical storage device 3 to the other side including the second bus line B2 in the powering prevalent state.

On the other hand, if the second bus line B2 is in the regeneration prevalent state and the first bus line B1 is in the powering prevalent state, then the determiner 42 selects (determines) the discharging mode (voltage step-down control mode) as the control mode. In the discharging mode, the control unit 4 performs switching control on the first switch element SW1 by turning the first switch element SW1 ON and OFF and performs control to keep the second switch element SW2 OFF, thereby using the electrical energy discharged from the electrical storage device 3 and stepped down as the energy for powering the first motor system 51. At this time, the control unit 4 sets a voltage value higher than the current voltage value (first measured value) of the voltage V_{L} between the first input/output terminal T11 and the second input/output terminal T12 as a target value as described above. Setting such a target value causes the control unit 4 to step up the voltage on the one side including the first bus line B1 to allow a current to flow from the electrical storage device 3 to the one side including the first bus line B1 in the powering prevalent state.

That is to say, the situation “where the second bus line B2 is in the regeneration prevalent state and the first bus line B1 is in the powering prevalent state” corresponds to the “particular condition” described above.

If each of the first bus line B1 and the second bus line B2 is in the powering prevalent state, basically the power supplied from each power supply (E1 or E2) is used. Also, if the first bus line B1 is in the powering prevalent state, then the electrical energy stored in the electrical storage device may be used to cut down the power supplied from the power supply E1 as much as possible.

### [Situation #2: Where Both Bus Lines are in Regeneration Prevalent State]

Suppose the decision made by the decider 41 indicates that both the first bus line B1 and the second bus line B2 are in the regeneration prevalent state. In that case, the control unit 4 controls the plurality of switch elements SW0 to step up the voltage on the other side including the second bus line B2 such that a current flows from the electrical storage device 3 toward the other side including the second bus line B2.

That is to say, in the Situation #2, the control unit 4 basically performs control similar to a case where the first bus line B1 is in the regeneration prevalent state and the second bus line B2 is in the powering prevalent state in the Situation #1 described above. That is to say, in the Situation #2, the determiner 42 selects (determines) the charging mode (voltage step-up control mode) as the control mode. In the charging mode, the control unit 4 performs switching control on the second switch element SW2 by turning the second switch element SW2 ON and OFF and performs control to keep the first switch element SW1 OFF, thereby stepping up the voltage of the regenerative power from the one side including the first bus line B1 to charge the electrical storage device 3 with the electric power thus stepped up. Note that the regenerative power on the other side including the second bus line B2 may be stored in the electrical storage device 3 as long as the regenerative power falls within the tolerance range of the electrical storage device 3.

Optionally, if the first bus line B1 and the second bus line B2 are both in the regeneration prevalent state, then the control unit 4 may further compare the magnitudes of increase in voltage between the first bus line B1 and the second bus line B2 and determine the control mode depending on the result of the comparison. For example, if the magnitude of increase in (the current) voltage value (from a first reference value) on the first bus line B1 is equal to or greater than the magnitude of increase in (the current) voltage value (from a second reference value) on the second bus line B2, then the determiner 42 may determine the control mode to be the charging mode. Note that the parameters to compare do not have to be the magnitudes of increase in voltage value but may also be, for example, the voltage rise rates during a predefined period.

Conversely, if the magnitude of increase in voltage on the second bus line B2 is greater than the magnitude of increase in voltage on the first bus line B1, then the determiner 42 may determine the control mode to be the standby mode. In the standby mode, the control unit 4 performs control to keep both the first switch element SW1 and the second switch element SW2 OFF (i.e., performs cutoff control). In that case, the regenerative power on the one side including the first bus line B1 may be consumed (i.e., discarded) by the resistor and other elements within the first configuration group A1. Even so, the regenerative power on the other side including the second bus line B2 may also be stored in the electrical storage device 3 as long as the regenerative power falls within the tolerance range of the electrical storage device 3.

### [Situation #3: Where Both Bus Lines are in Powering Prevalent State]

Suppose the decision made by the decider 41 indicates that both the first bus line B1 and the second bus line B2 are in the powering prevalent state. In that case, the control unit 4 suspends the switching operation to prevent a current from flowing from the electrical storage device 3 toward the one side including the first bus line B1 or the other side including the second bus line B2.

That is to say, in Situation #3, the determiner 42 basically determines the control mode to be the standby mode. In the standby mode, the control unit 4 performs control to keep both the first switch element SW1 and the second switch element SW2 OFF (i.e., performs cutoff control). In that case, the one side including the first bus line B1 and the other side including the second bus line B2 use the electric power supplied from the power supply E1 and the electric power supplied from the power supply E2, respectively.

Optionally, if both the first bus line B1 and the second bus line B2 are in the powering prevalent state, then the control unit 4 may further compare the magnitudes of decrease in voltage between the first bus line B1 and the second bus line B2 and determine the control mode depending on the result of the comparison. For example, if the magnitude of decrease in (the current) voltage value (from a first reference value) on the first bus line B1 is equal to or greater than the magnitude of decrease in (the current) voltage value (from a second reference value) on the second bus line B2, then the determiner 42 may determine the control mode to be the discharging mode. In that case, on the one side including the first bus line B1, the electric power supplied from the power supply E1 and the electrical energy stored in the electrical storage device 3 are used. On the other side including the second bus line B2, the electric power supplied from the power supply E2 is used. That is to say, the situation where both the first bus line B1 and the second bus line B2 are in the powering prevalent state and the magnitude of decrease in voltage on the first bus line B1 is equal to or greater than the magnitude of decrease in voltage on the second bus line B2 corresponds to the “particular condition” described above. Note that the parameters to compare do not have to be the magnitudes of decrease in voltage value but may also be, for example, the voltage drop rates during a predefined period.

Conversely, if the magnitude of decrease in voltage on the second bus line B2 is greater than the magnitude of decrease in voltage on the first bus line B1, then the determiner 42 may determine the control mode to be the standby mode. In that case, the one side including the first bus line B1 and the other side including the second bus line B2 use the electric power supplied from the power supply E1 and the electric power supplied from the power supply E2, respectively.

### How Regenerative Power Utilization System Works: Mode Determination

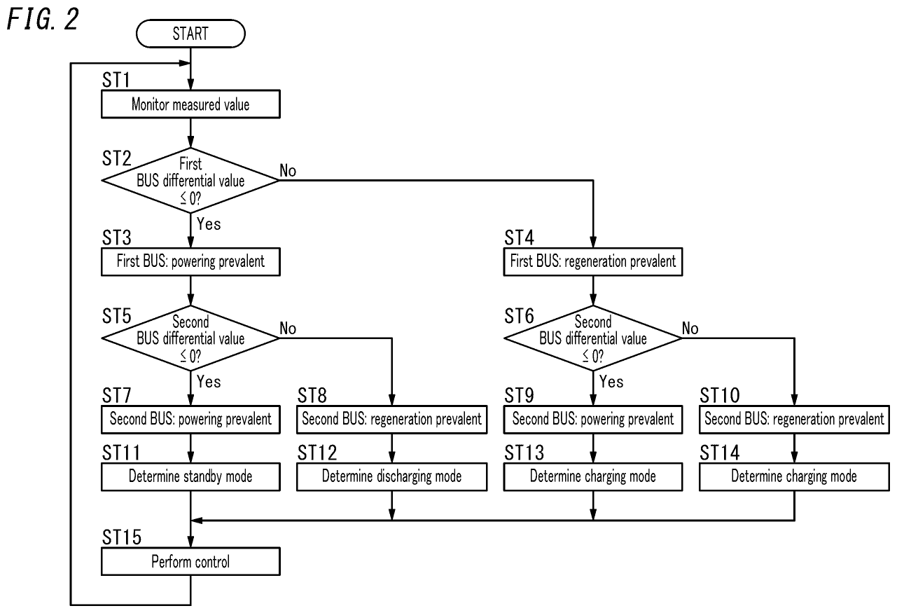

Next, an exemplary flow of a series of processing steps to be performed by the regenerative power utilization system 1 when determining the control mode will be described with reference to the flowchart shown in FIG. 2. Note that the flow of the processing steps to be described below is only an exemplary procedure and should not be construed as limiting. Optionally, those processing steps may be performed in a different order from the illustrated one, some of the processing steps may be omitted as appropriate, and/or an additional processing step may be performed as needed.

The (control unit 4 of the) regenerative power utilization system 1 monitors a first measured value supplied from the first measuring unit H1 and a second measured value supplied from the second measuring unit H2 (in ST1: monitor measured values).

The (decider 41 of the) control unit 4 determines, with respect to the one side including the first bus line B1, the sign of the differential value of the first measured value from the first reference value (in ST2: differential value on first BUS side≤0?). If the sign of the differential value is negative or if the differential value is equal to zero (if the answer is YES in ST2), then the decider 41 decides that the one side including the first bus line B1 be in the powering prevalent state (in ST3: powering prevalent on first BUS side).

Subsequent to ST3, the decider 41 determines, with respect to the other side including the second bus line B2, the sign of the differential value of the second measured value from the second reference value (in ST 5: differential value on second BUS side≤0?). If the sign of the differential value is negative or if the differential value is equal to zero (if the answer is YES in ST5), then the decider 41 decides that the other side including the second bus line B2 be in the powering prevalent state (in ST7: powering prevalent on second BUS side). The (determiner 42 of the) control unit 4 determines, based on the decisions made in Steps ST3 and ST7, the control mode to be the standby mode (in ST11).

On the other hand, if the sign of the differential value turns out to be positive in Step ST5 (if the answer is NO in ST5), then the decider 41 decides that the other side including the second bus line B2 be in the regeneration prevalent state (in ST8: regeneration prevalent on second BUS side). The determiner 42 determines, based on the decisions made in Steps ST3 and ST8, the control mode to be the discharging mode (in ST12).

Referring back to Step ST2, if the sign of the differential value of the first measured value from the first reference value turns out to be positive in Step ST2 (if the answer is NO in ST2), then the decider 41 decides that the one side including the first bus line B1 be in the regeneration prevalent state (in ST4: regeneration prevalent on first BUS side).

Subsequent to Step ST4, the decider 41 determines, with respect to the other side including the second bus line B2, the sign of the differential value of the second measured value from the second reference value (in ST 6: differential value on second BUS side≤0?). If the sign of the differential value is negative or if the differential value is equal to zero (if the answer is YES in ST6), then the decider 41 decides that the other side including the second bus line B2 be in the powering prevalent state (in ST9: powering prevalent on second BUS side). The determiner 42 determines, based on the decisions made in Steps ST4 and ST9, the control mode to be the charging mode (in ST13).

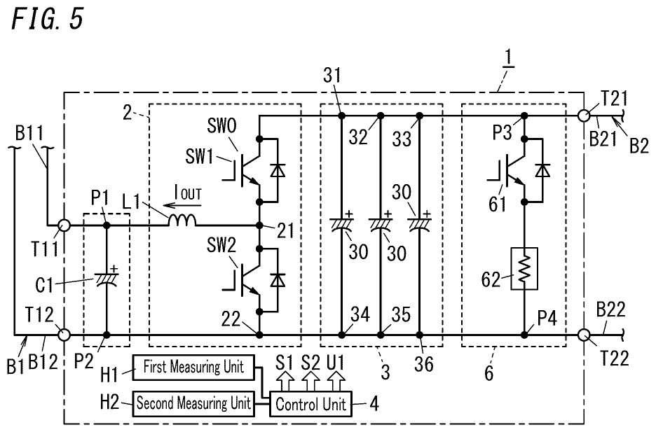

On the other hand, if the sign of the differential value turns out to be positive in Step ST6 (if the answer is NO in ST6), then the decider 41 decides that the other side including the second bus line B2 be in the regeneration prevalent state (in ST10: regeneration prevalent on second BUS side). The determiner 42 determines, based on the decisions made in Steps ST4 and ST10, the control mode to be the charging mode (in ST14). Nevertheless, if the charging mode is entered based on the result of the decision, then extra electric power would be generated. Thus, in that case, a resistor 62 (which may be a shunt resistor; refer to FIG. 5) to be described later with respect to the first variation is preferably provided for the other side including the second bus line B2 to consume the extra electric power. This is because the other side including the second bus line B2 has a higher voltage than the one side including the first bus line B1, thus allowing the current value to be reduced with respect to the same electric power. This allows the resistor 62 (shunt resistor) to have a lower rated current.

The control unit 4 performs control of the switch elements SW0 (in ST15) in any of the control modes thus determined (in any of ST11 to ST14). Then, the process returns to Step ST1, for example.

### How Regenerative Power Utilization System Works: Operation in Charging Mode

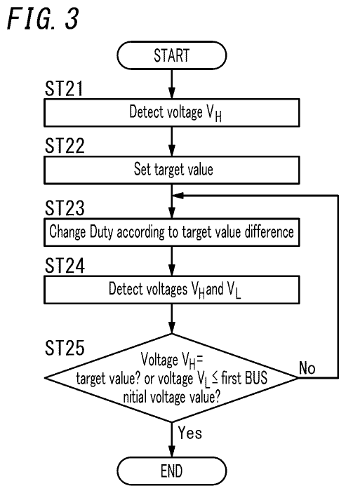

Next, an exemplary flow of a series of processing steps to be performed by the regenerative power utilization system 1 in the charging mode will be described with reference to the flowchart shown in FIG. 3. Note that the flow to be described below is only an exemplary procedure and should not be construed as limiting. Optionally, these processing steps may be performed in a different order from the illustrated one, some of the processing steps may be omitted as appropriate, and/or an additional processing step may be performed as needed.

To start performing control in the charging mode, the (acquirer 40 of the control unit 4 of the) regenerative power utilization system 1 first acquires, from the second measuring unit H2, the voltage V_{H} between the first input/output terminal T21 and the second input/output terminal T22 on the other side including the second bus line B2 (in ST21: detect voltage V_{H}).

The control unit 4 sets a voltage value higher than the voltage value (second measured value) of the voltage V_{H} detected in Step ST21 as a target value (in ST22: set target value).

Then, the control unit 4 sets (or changes) the duty according to the difference (target value difference) between the target value and the last second measured value to perform switching control on the second switch element SW2 by turning ON and OFF the second switch element SW2 (in ST23: change Duty according to target value difference). In the charging mode, the control unit 4 performs control to keep the first switch element SW1 OFF.

Next, the control unit 4 detects the voltage V_{H} and a voltage V_{L} (between the first input/output terminal T11 and the second input/output terminal T12 on the one side including the first bus line B1) (in ST24). That is to say, the acquirer 40 of the control unit 4 acquires the voltage V_{H} from the second measuring unit H2 and further acquires the voltage V_{L} from the first measuring unit H1.

The control unit 4 determines whether or not a first condition that voltage V_{H}=target value is satisfied and whether or not a second condition that voltage V_{L}≤initial voltage value on the one side including the first bus line B1 (first BUS side) is satisfied (in ST25). As used herein, the initial voltage value on the one side including the first bus line B1 (first BUS side) may refer to, for example, a first reference value (standard voltage value) used to determine whether the first bus line B1 is in the powering prevalent state or the regeneration prevalent state. Alternatively, the initial voltage value may also be a preset value defined in advance separately from the first reference value.

When deciding that the first condition or the second condition be satisfied (if the answer is YES in Step ST25), the control unit 4 ends the control in the charging mode. On the other hand, when deciding that neither the first condition nor the second condition be satisfied (if the answer is NO in Step ST25), then the control unit 4 returns to Step ST23. Then, the control unit 4 changes the duty according to the difference (target value difference) between the target value and the last second measured value (acquired in Step ST24) to perform switching control on the second switch element SW2 by turning ON and OFF the second switch element SW2. In other words, according to this embodiment, unless the first condition or the second condition is satisfied, the control unit 4 may continue performing control in the charging mode as an example.

### How Regenerative Power Utilization System Works: Operation in Discharging Mode

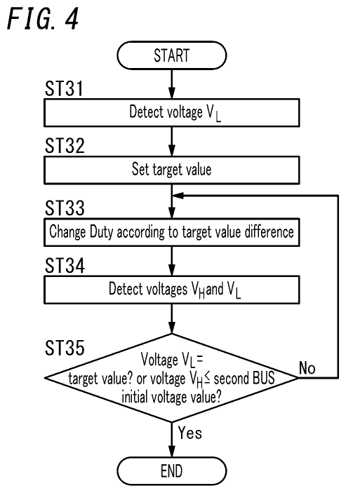

Next, an exemplary flow of a series of processing steps to be performed by the regenerative power utilization system 1 in the discharging mode will be described with reference to the flowchart shown in FIG. 4. Note that the flow to be described below is only an exemplary procedure and should not be construed as limiting. Optionally, these processing steps may be performed in a different order from the illustrated one, some of the processing steps may be omitted as appropriate, and/or an additional processing step may be performed as needed.

To start performing control in the discharging mode, the (acquirer 40 of the control unit 4 of the) regenerative power utilization system 1 first acquires, from the first measuring unit H1, the voltage V_{L} between the first input/output terminal T11 and the second input/output terminal T12 on the one side including the first bus line B1 (in ST31: detect voltage V_{L}).

The control unit 4 sets a voltage value higher than the voltage value (first measured value) of the voltage V_{L} detected in Step ST31 as a target value (in ST32: set target value).

Then, the control unit 4 sets (or changes) the duty according to the difference (target value difference) between the target value and the last first measured value to perform switching control on the first switch element SW1 by turning ON and OFF the first switch element SW1 (in ST33: change Duty according to target value difference). In the discharging mode, the control unit 4 performs control to keep the second switch element SW2 OFF.

Next, the control unit 4 detects a voltage V_{H} (between the first input/output terminal T21 and the second input/output terminal T22 on the other side including the second bus line B2) and the voltage V_{L} (in ST34). That is to say, the acquirer 40 of the control unit 4 acquires the voltage V_{L} from the first measuring unit H1 and further acquires the voltage V_{H} from the second measuring unit H2.

The control unit 4 determines whether or not a third condition that voltage V_{L}=target value is satisfied and whether or not a fourth condition that voltage V_{H}≤initial voltage value on the other side including the second bus line B2 (second BUS side) is satisfied (in ST35). As used herein, the initial voltage value on the other side including the second bus line B2 (second BUS side) may refer to, for example, a second reference value (standard voltage value) used to determine whether the second bus line B2 is in the powering prevalent state or the regeneration prevalent state. Alternatively, the initial voltage value may also be a preset value defined in advance separately from the second reference value.

When deciding that the third condition or the fourth condition be satisfied (if the answer is YES in Step ST35), the control unit 4 ends the control in the discharging mode. On the other hand, when deciding that neither the third condition nor the fourth condition be satisfied (if the answer is NO in Step ST35), then the control unit 4 returns to Step ST33. Then, the control unit 4 changes the duty according to the difference (target value difference) between the target value and the last first measured value (acquired in Step ST34) to perform switching control on the first switch element SW1 by turning ON and OFF the first switch element SW1. In other words, according to this embodiment, unless the third condition or the fourth condition is satisfied, the control unit 4 may continue performing control in the discharging mode as an example.

### [Advantages]

As can be seen from the foregoing description, in the regenerative power utilization system 1 according to this embodiment, the regenerative power generated by the first motor system 51 and the second motor system 52, of which the motors M1 have different voltage specifications, is stored in the electrical storage device 3. In addition, the electrical energy stored in the electrical storage device 3 is also used as electrical energy for powering the first motor system 51. This reduces the chances of the regenerative power generated by the first motors M11, for example, being consumed (discarded) within the first motor system 51. This also allows the regenerative power utilization system 1 to use the powering energy efficiently. Consequently, the regenerative power utilization system 1 achieves the advantage of contributing to improvement on the utilization of the regenerative power.

In addition, according to this embodiment, the electrical storage device 3 is connected to the power converter circuit 2 between the other side including the second bus line B2 and the power converter circuit 2. This makes it easier to store, by using, for example, an electrical storage device 3 with a high breakdown voltage, the regenerative power, generated by the second motor system 52 having the higher voltage specification, in the electrical storage device 3 more efficiently without stepping down the voltage of the regenerative power. In particular, according to this embodiment, the electrical storage device 3 is provided on the other side including the second bus line B2. Thus, if the second bus line B2 turns into the powering prevalent state, for example, the electrical energy stored in the electrical storage device 3 may be used as energy for powering the second motor system 52 (in any control mode as needed).

Furthermore, according to this embodiment, regarding each of the first bus line B1 and the second bus line B2, the regenerative power utilization system 1 decides whether a corresponding bus line is in the powering prevalent state or the regeneration prevalent state and determines the control mode according to the combination of the decisions. This allows the regenerative power utilization system 1 according to this embodiment to control the power converter circuit 2 more appropriately.

### First Variation

Next, a regenerative power utilization system 1 according to one variation (first variation) will be described in detail with reference to FIG. 5. In the following description, any constituent element of the regenerative power utilization system 1 according to this first variation, having substantially the same function as a counterpart of the regenerative power utilization system 1 according to the exemplary embodiment described above, will be designated by the same reference numeral as that counterpart's, and description thereof will be omitted as appropriate herein. Note that FIG. 5 illustrates only a configuration for the regenerative power utilization system 1 according to the first variation with illustration of the configurations of the first motor system 51 and the second motor system 52 omitted.

The regenerative power utilization system 1 according to the first variation further includes a capacitor C1 and a power consumption unit 6 as shown in FIG. 5, which is a difference from the regenerative power utilization system 1 according to the exemplary embodiment described above.

The capacitor C1 is disposed between the one side including the first bus line B1 and the power converter circuit 2. The capacitor C1 has a first terminal and a second terminal. The first terminal of the capacitor C1 is electrically connected to the first electrical path B11 of the first bus line B1. The second terminal of the capacitor C1 is electrically connected to the second electrical path B12 of the first bus line B1. Specifically, the first terminal of the capacitor C1 is electrically connected to a connection node P1 between the first input/output terminal T11 and the first terminal of the inductor L1. The second terminal of the capacitor C1 is connected to a connection node P2 between the second input/output terminal T12 and the connection node 22. The capacitor C1 is supposed to be, for example, an electrolytic capacitor with a low breakdown voltage.

Disposing the capacitor C1 between the one side including the first bus line B1 and the power converter circuit 2 in this manner allows, when a relatively large amount of current flows from the one side including the first bus line B1 into the regenerative power utilization system 1, the relatively large amount of current to be smoothed by the capacitor C1. This allows for reducing, when the regenerative power increases steeply on the one side including the first bus line B1, for example, the voltage rise rate as a transient response of the regenerative power utilization system 1. In other words, the control unit 4 configured to select the control mode by deciding, based on the first measured value measured by the first measuring unit H1, whether the first bus line B1 is in the powering prevalent state or the regeneration prevalent state could not catch up immediately with a steep increase in regenerative power in some cases. Providing the capacitor C1, however, may reduce such a steep increase in regenerative power. Note that in the first variation, the first measuring unit H1 is disposed on the other side, opposite from the power converter circuit 2, of the capacitor C1 (i.e., on the same side as the power converter circuit 2) to measure the voltage V_{L} at both terminals closer to the motors than the connection nodes P1 and P2 are.

The power consumption unit 6 is disposed between the other side including the second bus line B2 and the power converter circuit 2. The power consumption unit 6 includes a particular switch element 61 and a resistor 62. The particular switch element 61 has switching of its ON/OFF states controlled by the control unit 4. The resistor 62 is connected to the particular switch element 61 in series.

Specifically, the particular switch element 61 may be an IGBT, for example. Thus, the control terminal, first main terminal, and second main terminal of the particular switch element 61 may be a gate terminal, a collector terminal, and an emitter terminal, respectively. However, this is only an example and should not be construed as limiting. The particular switch element 61 does not have to be an IGBT but may also be, for example, a MOSFET, a bipolar transistor, or a GaN-based transistor. The resistor 62 may serve as, for example, a shunt resistor for branching a part of an electrical current flowing from the other side including the second bus line B2 toward the electrical storage device 3. The resistor 62 has a first terminal and a second terminal.

The first main terminal of the particular switch element 61 is electrically connected to a connection node P3 between a connection node 33 and the first input/output terminal T21. The second main terminal of the particular switch element 61 is electrically connected to the first terminal of the resistor 62. The second terminal of the resistor 62 is electrically connected to a connection node P4 between a connection node 36 and the second input/output terminal T22. Alternatively, the particular switch element 61 and the resistor 62 may be connected in reverse order. Specifically, in that case, the first terminal of the resistor 62 may be connected to the connection node P3, the second terminal of the resistor 62 may be connected to the first main terminal of the particular switch element 61, and the second main terminal of the particular switch element 61 may be connected to the connection node P4. The control terminal of the particular switch element 61 is electrically connected to the control unit 4.

The control unit 4 performs ON-state control on the particular switch element 61 to have the extra power (of the regenerative power) generated on the other side including the second bus line B2 consumed by the resistor 62. The specifics of the control will be described below.

In the first variation, the control unit 4 is configured to, if a predefined condition is satisfied in a situation where the other side including the second bus line B2 is in the regeneration prevalent state, perform extra power processing. The extra power processing is performed whenever the predefined condition is satisfied, no matter which of the charging mode, the discharging mode, and the standby mode already described for the exemplary embodiment the control unit 4 is performing control. For example, if the other side including the second bus line B2 is in the regeneration prevalent state, then regenerative power could be generated to a quantity exceeding an allowable quantity of electrical energy storable in the electrical storage device 3 (i.e., a capacity that can be stored in the electrical storage device at the current point in time). The predefined condition may be, for example, that the quantity of the regenerative power generated on the other side including the second bus line B2 exceed a certain quantity that has been set based on the allowable quantity of electrical energy storable in the electrical storage device 3. When the quantity of the regenerative power generated on the other side including the second bus line B2 exceeds the certain quantity (i.e., when the predefined condition is satisfied), the control unit 4 may start performing the extra power processing.

While the extra power processing is not being performed, the particular switch element 61 is kept OFF. In performing the extra power processing, the control unit 4 generates a control signal U1 (refer to FIG. 5) for use to perform the ON-state control on the particular switch element 61 and outputs the control signal U1 to the control terminal of the particular switch element 61. As a result, while the extra power processing is being performed, the particular switch element 61 is kept ON and the extra power is consumed by the resistor 62. If the predefined condition turns out to be unsatisfied while the extra power processing is being performed, then the control unit 4 controls the particular switch element 61 toward OFF state to finish performing the extra power processing.

Examples of application of the extra power processing include [Situation #2: where both bus lines are in regeneration prevalent state] as already described for the exemplary embodiment. In Situation #2, if the magnitude of increase in voltage on the second bus line B2 is greater than the magnitude of increase in voltage on the first bus line B1, the determiner 42 may determine the control mode to be the standby mode as described above. For example, if the predefined condition is satisfied during the standby mode, the control unit 4 may start performing the extra power processing.

If the quantity of the extra power to be generated is expected to be too much to be consumed by the resistor 62, then the control unit 4 may perform control to prevent the electrical storage device 3 from being charged with electrical energy by performing abortion processing for protection purposes. The regenerative power utilization system 1 may further include, for example, a switch element such as an IGBT for use to interrupt the electrical path leading from the other side including the second bus line B2 to the electrical storage device 3 and may interrupt the electrical path by turning OFF (i.e., opening) the switch element while performing the abortion processing.

Providing such a power consumption unit 6 allows, in a situation where regenerative power (extra power) is generated on the other side including the second bus line B2 to the quantity exceeding the allowable range, the resistor 62 to consume the extra power. In other words, this contributes to increasing the allowable power consumption of the regenerative power in the regenerative power utilization system 1. Consequently, this contributes to stabilizing the regenerative power on the second bus line B2.

Alternatively, the power consumption unit 6 may also be disposed on the one side including the first bus line B1. Nevertheless, disposing the power consumption unit 6 on the other side including the second bus line B2 (having a higher voltage than the first bus line B1) as described above makes the amount of current flowing more constant with the same power consumption. In other words, disposing the power consumption unit 6 on the other side including the second bus line B2 allows for increasing the power consumption of the power consumption unit 6. Thus, disposing the power consumption unit 6 on the other side including the second bus line B2 allows the regenerative power utilization system 1 to achieve higher efficiency as a whole than disposing the power consumption unit 6 on the one side including the first bus line B1.

### Second Variation

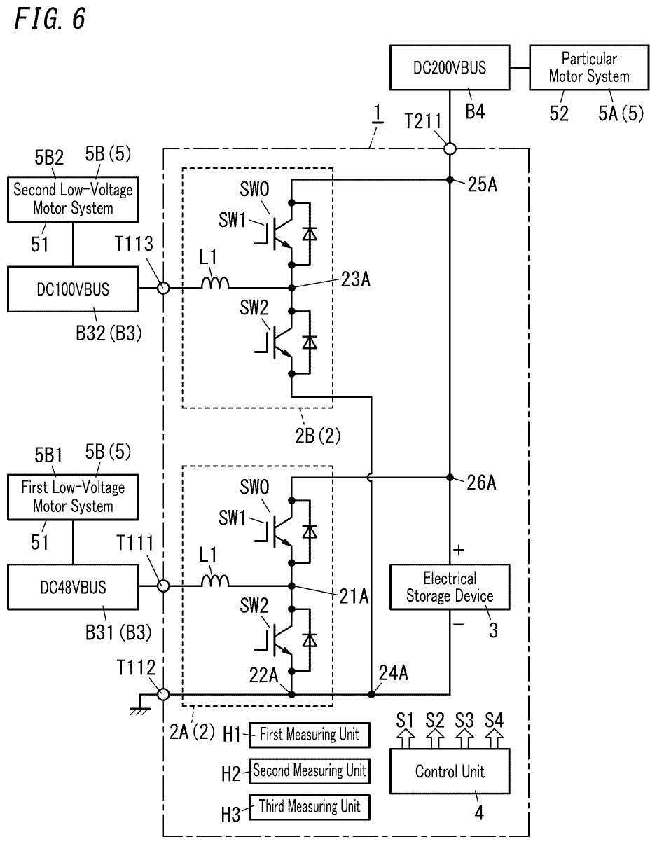

Next, a regenerative power utilization system 1 according to another variation (second variation) will be described in detail with reference to FIG. 6. In the following description, any constituent element of the regenerative power utilization system 1 according to this second variation, having substantially the same function as a counterpart of the regenerative power utilization system 1 according to the exemplary embodiment described above, will be designated by the same reference numeral as that counterpart's, and description thereof will be omitted as appropriate herein. Note that in FIG. 6, the electrical storage device 3, the motor systems 5, and the bus lines are illustrated in a simplified form as blocks. In addition, in FIG. 6, illustration of some constituent elements of the motor management system 100, such as the power supplies E1, E2 and the rectifiers F1, F2, is omitted.

The regenerative power utilization system 1 according to the second variation is applied to three types of motor systems 5 as shown in FIG. 6, which is a difference from the regenerative power utilization system 1 according to exemplary embodiment described above.

Specifically, in the exemplary embodiment described above, the first motor system 51 and the second motor system 52 have been described as an example as at least two types of motor systems 5 to which the regenerative power utilization system 1 is applicable. In the second variation, the at least two types of motor systems 5, to which the regenerative power utilization system 1 is applicable, includes three or more types of motor systems 5. Each of the three or more types of motor systems 5 includes one or more motors M1. The one or more motors M1 included in each of the three or more types of motor systems 5 have a different voltage specification from the one or more motors M1 included in any other one of the three or more types of motor systems 5. The three or more types of motor systems 5 include a particular motor system 5A including one or more motors M1 having the highest voltage specification and a plurality of low-voltage motor systems 5B other than the particular motor system 5A. Each of the plurality of low-voltage motor systems 5B is defined as the first motor system 51 according to the exemplary embodiment described above. The particular motor system 5A is defined as the second motor system 52 according to the exemplary embodiment described above.

In the following description, the three or more types of motor systems 5 are supposed to be, for example, the particular motor system 5A (corresponding to the second motor system 52), a first low-voltage motor system 5B1 (corresponding to the first motor system 51), and a second low-voltage motor system 5B2 (also corresponding to the first motor system 51). That is to say, the number of the plurality of low-voltage motor systems 5B may be two, for example.

The regenerative power utilization system 1 according to the second variation includes a plurality of power converter circuits 2. In FIG. 6, the plurality of power converter circuits 2 provided are supposed to be as many as the plurality of low-voltage motor systems 5B. Specifically, in FIG. 6, the number of the power converter circuits 2 provided and the number of the low-voltage motor systems 5B provided are both two. The plurality of power converter circuits 2 are connected to the plurality of low-voltage bus lines B3 and a particular bus line B4 to satisfy the following requirement. Specifically, the requirement to satisfy is that the output voltage value after the voltage of the regenerative power supplied from each of the plurality of low-voltage bus lines B3, respectively corresponding to the plurality of low-voltage motor systems 5B, has been stepped up be the voltage value of the particular bus line B4 corresponding to the particular motor system 5A. In the following description, the connection between the electrical storage device 3 and the plurality of power converter circuits 2 and other circuit components will be described in detail.

The regenerative power utilization system 1 according to the second variation includes input/output terminals T111, T112, T113, and T211 as shown in FIG. 6.

The electrical storage device 3 is supposed to include a plurality of electrolytic capacitors 30 (not shown in FIG. 6) having a breakdown voltage higher than the maximum voltage value of the highest bus voltage in the system, e.g., a breakdown voltage of 400 V. The plurality of electrolytic capacitors 30 are connected to each other in parallel. The higher potential terminal of the electrical storage device 3 is electrically connected to the input/output terminal T211 via connection nodes 26A and 25A. The lower potential terminal of the electrical storage device 3 is electrically connected to the input/output terminal T112 (to be connected to GND) via connection nodes 24A and 22A.

The first low-voltage motor system 5B1 includes one or more motors M1 having a voltage specification with a rated voltage of 48 V and power converter units (not shown in FIG. 6). The first low-voltage motor system 5B1 is connected to a low-voltage bus line B3 (e.g., a DC 48 V bus line B31 labeled as “DC 48 V BUS” in FIG. 6), which is a DC 48 V bus line corresponding to the first bus line B1 according to the exemplary embodiment described above. The first low-voltage motor system 5B1 is supplied with electric power from a power supply (not shown in FIG. 6) via a rectifier (not shown in FIG. 6, either) and the DC 48 V bus line B31.

The DC 48 V bus line B31 is electrically connected to one (hereinafter referred to as a “first power converter circuit 2A”) of the two power converter circuits 2. Specifically, the higher-potential electrical path of the DC 48 V bus line B31 is electrically connected to the input/output terminal T111. Note that the input/output terminal T112 is connected to GND (e.g., frame ground) and the lower-potential electrical path of the DC 48 V bus line B31 is also connected to GND.

The first power converter circuit 2A has substantially the same circuit configuration per se as the power converter circuit 2 according to the exemplary embodiment described above, and therefore, detailed description thereof will be omitted herein except its connection. In the first power converter circuit 2A, a first terminal of the inductor L1 is electrically connected to the input/output terminal T111 and a second terminal of the inductor L1 is electrically connected to a connection node 21A. In the first power converter circuit 2A, a first main terminal of the first switch element SW1 is electrically connected to a connection node 26A between a connection node 25A and the higher potential terminal of the electrical storage device 3, and a second main terminal of the first switch element SW1 is electrically connected to a connection node 21A. In the first power converter circuit 2A, a control terminal of the first switch element SW1 is electrically connected to the control unit 4 and the first switch element SW1 has its ON/OFF states controlled in accordance with a control signal S1 supplied from the control unit 4. In the first power converter circuit 2A, a first main terminal of the second switch element SW2 is electrically connected to the connection node 21A and a second main terminal of the second switch element SW2 is electrically connected to a connection node 22A between the input/output terminal T112 and a connection node 24A. In the first power converter circuit 2A, a control terminal of the second switch element SW2 is electrically connected to the control unit 4 and the second switch element SW2 has its ON/OFF states controlled in accordance with a control signal S2 supplied from the control unit 4.

The second low-voltage motor system 5B2 includes one or more motors M1 having a voltage specification with a rated voltage of 100 V and power converter units (not shown in FIG. 6). The second low-voltage motor system 5B2 is connected to a low-voltage bus line B3 (e.g., a DC 100 V bus line B32 labeled as “DC 100 V BUS” in FIG. 6), which is a DC 100 V bus line corresponding to the other first bus line B1. The second low-voltage motor system 5B2 is supplied with electric power from a power supply (not shown in FIG. 6) via a rectifier (not shown in FIG. 6, either) and the DC 100 V bus line B32.

The DC 100 V bus line B32 is electrically connected to the other (hereinafter referred to as a “second power converter circuit 2B”) of the two power converter circuits 2. Specifically, the higher-potential electrical path of the DC 100 V bus line B32 is electrically connected to the input/output terminal T113. Note that the lower-potential electrical path of the DC 100 V bus line B32 is connected to GND.

The second power converter circuit 2B has substantially the same circuit configuration per se as the power converter circuit 2 according to the exemplary embodiment described above, and therefore, detailed description thereof will be omitted herein except its connection. In the second power converter circuit 2B, a first terminal of the inductor L1 is electrically connected to the input/output terminal T113 and a second terminal of the inductor L1 is electrically connected to a connection node 23A. In the second power converter circuit 2B, a first main terminal of the first switch element SW1 is electrically connected to a connection node 25A between the input/output terminal T211 and a connection node 26A, and a second main terminal of the first switch element SW1 is electrically connected to a connection node 23A. In the second power converter circuit 2B, a control terminal of the first switch element SW1 is electrically connected to the control unit 4 and the first switch element SW1 has its ON/OFF states controlled in accordance with a control signal S3 supplied from the control unit 4. In the second power converter circuit 2B, a first main terminal of the second switch element SW2 is electrically connected to the connection node 23A and a second main terminal of the second switch element SW2 is electrically connected to the connection node 24A between the lower potential terminal of the electrical storage device 3 and the connection node 22A. In the second power converter circuit 2B, a control terminal of the second switch element SW2 is electrically connected to the control unit 4 and the second switch element SW2 has its ON/OFF states controlled in accordance with a control signal S4 supplied from the control unit 4.

The particular motor system 5A includes one or more motors M1 having a voltage specification with a rated voltage of 200 V and power converter units (not shown in FIG. 6). The particular motor system 5A is connected to the particular bus line B4 (labeled as “DC 200 V BUS” in FIG. 6), which is a DC 200 V bus line corresponding to the second bus line B2 according to the exemplary embodiment described above. The particular motor system 5A is supplied with electric power from a power supply (not shown in FIG. 6) via a rectifier (not shown in FIG. 6, either) and the particular bus line B4.

The higher-potential electrical path of the particular bus line B4 is electrically connected to the input/output terminal T211 and the lower-potential electrical path of the particular bus line B4 is connected to GND.

In short, both the first power converter circuit 2A and the second power converter circuit 2B are connected to the particular bus line B4 in the particular motor system 5A having the highest voltage specification. According to this connection, the output voltage value in the charging mode (voltage step-up control mode) of each of the first power converter circuit 2A and the second power converter circuit 2B corresponds to the voltage value of the particular bus line B4 in the particular motor system 5A having the highest voltage specification. Also, according to this connection, the output voltage value in the discharging mode (voltage step down control mode) of the first power converter circuit 2A corresponds to the voltage value of the first low-voltage bus line (i.e., DC 48 V bus line B31) and the output voltage value in the discharging mode (voltage step down control mode) of the second power converter circuit 2B corresponds to the voltage value of the second low-voltage bus line (i.e., DC 100 V bus line B32). Simply speaking, the first power converter circuit 2A serves as a 48V/200V converter circuit and the second power converter circuit 2B serves as a 100V/200V converter circuit.

The regenerative power utilization system 1 according to the second variation includes the first measuring unit H1, the second measuring unit H2, and a third measuring unit H3 as shown in FIG. 6. The first measuring unit H1 measures (detects) the voltage between the input/output terminals T111 and T112 to output a first measured value to the control unit 4. The second measuring unit H2 measures (detects) the voltage between the input/output terminals T211 and T112 to output a second measured value to the control unit 4. The third measuring unit H3 measures (detects) the voltage between the input/output terminals T113 and T112 to output a third measured value to the control unit 4.

In the second variation, the control unit 4 decides, based on the first measured value, whether the DC 48 V bus line B31 is in the powering prevalent state or the regeneration prevalent state. The control unit 4 decides, based on the second measured value, whether the particular bus line B4 is in the powering prevalent state or the regeneration prevalent state. The control unit 4 determines the control mode according to the combination of these results of decision. Then, the control unit 4 controls the first switch element SW1 and the second switch element SW2 of the first power converter circuit 2A in the control mode thus determined.

In addition, the control unit 4 also decides based on the third measured value whether the DC 100 V bus line B32 is in the powering prevalent state or the regeneration prevalent state. The control unit 4 decides, based on the second measured value, whether the particular bus line B4 is in the powering prevalent state or the regeneration prevalent state. The control unit 4 determines the control mode according to the combination of these results of decision. Then, the control unit 4 controls the first switch element SW1 and the second switch element SW2 of the second power converter circuit 2B in the control mode thus determined.

In short, the control unit 4 according to the second variation determines the control mode on an individual basis with respect to each of the power converter circuits 2.

As can be seen from the foregoing description, the second variation makes it easier to apply the regenerative power utilization system 1 to even three types of motor systems 5, thus contributing to improvement on the utilization of regenerative power. Optionally, the regenerative power utilization system 1 is also applicable to even four or more types of motor systems 5 by increasing the number of the power converter circuits 2 provided and connecting the power converter circuits 2 in a similar manner. For example, if a fourth motor system is additionally provided for the configuration of this second variation, then a fourth power converter circuit corresponding to the fourth motor system is additionally provided. In that case, the connection may be adjusted such that the output voltage value of the fourth power converter circuit in the charging mode corresponds to the voltage value of the particular bus line B4 of the particular motor system 5A.

### Third Variation

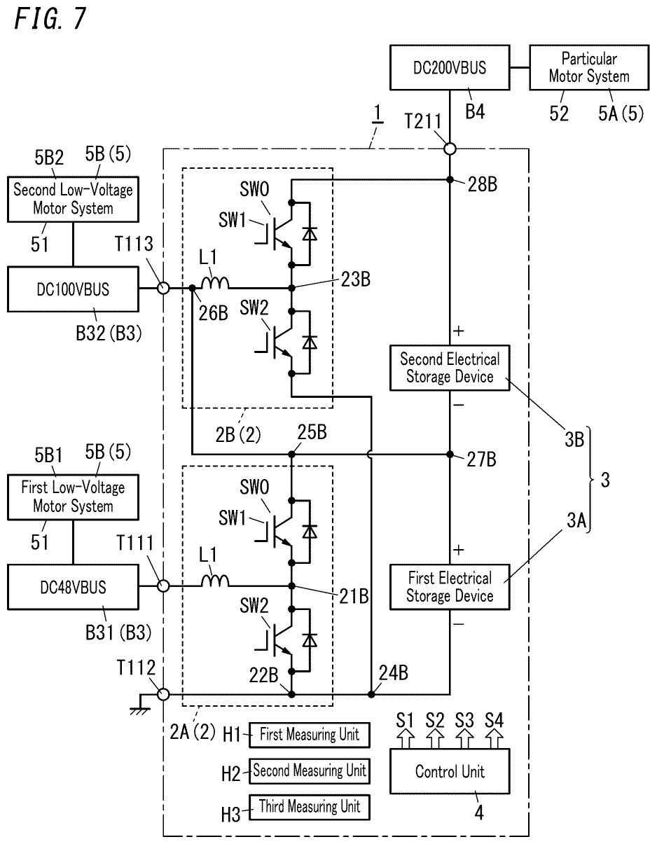

Next, a regenerative power utilization system 1 according to still another variation (third variation) will be described in detail with reference to FIG. 7. In the following description, any constituent element of the regenerative power utilization system 1 according to this third variation, having substantially the same function as a counterpart of the regenerative power utilization system 1 according to the exemplary embodiment described above, will be designated by the same reference numeral as that counterpart's, and description thereof will be omitted as appropriate herein. Note that in FIG. 7, as well as in FIG. 6, the electrical storage device 3, the motor systems 5, and the bus lines are illustrated in a simplified form as blocks. In addition, in FIG. 7, as well as in FIG. 6, illustration of some constituent elements of the motor management system 100, such as the power supplies E1, E2 and the rectifiers F1, F2, is omitted.

The regenerative power utilization system 1 according to the third variation is applied, as in the second variation described above, to three or more types of motor systems 5 as shown in FIG. 7, which is a difference from the regenerative power utilization system 1 according to exemplary embodiment described above. Nevertheless, in the regenerative power utilization system 1 according to the third variation, the plurality of power converter circuits 2 are connected differently from in the second variation described above. In addition, in the regenerative power utilization system 1 according to the third variation, the electrical storage device 3 includes a first electrical storage unit 3A and a second electrical storage unit 3B, which is a difference from the second variation described above.

Specifically, in the third variation, the at least two types of motor systems 5, to which the regenerative power utilization system 1 is applicable, includes three or more types of motor systems 5 as in the second variation described above. Each of the three or more types of motor systems 5 includes one or more motors M1. The one or more motors M1 included in each of the three or more types of motor systems 5 have a different voltage specification from the one or more motors M1 included in any other one of the three or more types of motor systems 5. The three or more types of motor systems 5 include a particular motor system 5A including one or more motors M1 having the highest voltage specification and a plurality of low-voltage motor systems 5B other than the particular motor system 5A. Each of the plurality of low-voltage motor systems 5B is defined as the first motor system 51 according to the exemplary embodiment described above. The particular motor system 5A is defined as the second motor system 52 according to the exemplary embodiment described above.

In the following description, the three or more types of motor systems 5 are supposed to be, for example, the particular motor system 5A (corresponding to the second motor system 52), the first low-voltage motor system 5B1 (corresponding to the first motor system 51), and the second low-voltage motor system 5B2 (also corresponding to the first motor system 51) as in the second variation described above. That is to say, the number of the plurality of low-voltage motor systems 5B may be two, for example.

The regenerative power utilization system 1 according to the third variation includes a plurality of power converter circuits 2. In FIG. 7, the plurality of power converter circuits 2 provided are supposed to be as many as the plurality of low-voltage motor systems 5B. Specifically, in FIG. 7, the number of the power converter circuits 2 provided and the number of the low-voltage motor systems 5B provided are both two. The plurality of power converter circuits 2 are connected to the plurality of low-voltage bus lines B3 and a particular bus line B4 to satisfy the following first and second requirements. Specifically, the first requirement to satisfy is that the output voltage value after the voltage of the regenerative power supplied from a first low-voltage bus line (DC 48 V bus line B31) out of the plurality of low-voltage bus lines B3, respectively corresponding to the plurality of low-voltage motor systems 5B, has been stepped up be the voltage value of a second low-voltage bus line (DC 100 V bus line B32). The second requirement to satisfy is that the output voltage value after the voltage of the regenerative power supplied from the second low-voltage bus line has been stepped up be the voltage value of the particular bus line B4 corresponding to the particular motor system 5A. In the following description, the connection between the electrical storage device 3 and the plurality of power converter circuits 2 and other components will be described in detail. Description of the same features as those of the second variation described above will be omitted herein as appropriate.

The electrical storage device 3 includes the first electrical storage unit 3A and the second electrical storage unit 3B as described above. The first electrical storage unit 3A is supposed to include, for example, a plurality of electrolytic capacitors 30 (not shown in FIG. 7) having a breakdown voltage of 200 V which are connected to each other in parallel. The second electrical storage unit 3B is also supposed to include, for example, a plurality of electrolytic capacitors 30 (not shown in FIG. 7) having a breakdown voltage of 200 V which are connected to each other in parallel. The higher potential terminal of the first electrical storage unit 3A is electrically connected to the lower potential terminal of the second electrical storage unit 3B via a connection node 27B. The lower potential terminal of the first electrical storage unit 3A is electrically connected to the input/output terminal T112 (to be connected to GND) via connection nodes 24B and 22B. The higher potential terminal of the second electrical storage unit 3B is electrically connected to the input/output terminal T211 via a connection node 28B.

The first low-voltage motor system 5B1 is connected to the low-voltage bus lines B3 (i.e., DC 48 V bus line B31). The DC 48 V bus line B31 is electrically connected to the first power converter circuit 2A. Specifically, the higher-potential electrical path of the DC 48 V bus line B31 is electrically connected to the input/output terminal T111. Note that the input/output terminal T112 is connected to GND and the lower-potential electrical path of the DC 48 V bus line B31 is also connected to GND.

In the first power converter circuit 2A, a first terminal of the inductor L1 is electrically connected to the input/output terminal T111 and a second terminal of the inductor L1 is electrically connected to a connection node 21B. In the first power converter circuit 2A, a first main terminal of the first switch element SW1 is electrically connected to a connection node 25B between a connection node 26B and a connection node 27B, and a second main terminal of the first switch element SW1 is electrically connected to the connection node 21B. In the first power converter circuit 2A, a control terminal of the first switch element SW1 is electrically connected to the control unit 4 and the first switch element SW1 has its ON/OFF states controlled in accordance with a control signal S1 supplied from the control unit 4. In the first power converter circuit 2A, a first main terminal of the second switch element SW2 is electrically connected to the connection node 21B and a second main terminal of the second switch element SW2 is electrically connected to a connection node 22B between the input/output terminal T112 and a connection node 24B. In the first power converter circuit 2A, a control terminal of the second switch element SW2 is electrically connected to the control unit 4 and the second switch element SW2 has its ON/OFF states controlled in accordance with a control signal S2 supplied from the control unit 4.

The second low-voltage motor system 5B2 is connected to the other low-voltage bus lines B3 (i.e., DC 100 V bus line B32). The DC 100 V bus line B32 is electrically connected to the second power converter circuit 2B. Specifically, the higher-potential electrical path of the DC 100 V bus line B32 is electrically connected to the input/output terminal T113. Note that the lower-potential electrical path of the DC 100 V bus line B32 is connected to GND.

In the second power converter circuit 2B, a first terminal of the inductor L1 is electrically connected to the input/output terminal T113 via a connection node 26B and a second terminal of the inductor L1 is electrically connected to a connection node 23B. Note that the connection node 26B is electrically connected to a connection node 27B between the first electrical storage unit 3A and the second electrical storage unit 3B via a connection node 25B. In the second power converter circuit 2B, a first main terminal of the first switch element SW1 is electrically connected to a connection node 28B, and a second main terminal of the first switch element SW1 is electrically connected to the connection node 23B. In the second power converter circuit 2B, a control terminal of the first switch element SW1 is electrically connected to the control unit 4 and the first switch element SW1 has its ON/OFF states controlled in accordance with a control signal S3 supplied from the control unit 4. In the second power converter circuit 2B, a first main terminal of the second switch element SW2 is electrically connected to the connection node 23B and a second main terminal of the second switch element SW2 is electrically connected to the connection node 24B. In the second power converter circuit 2B, a control terminal of the second switch element SW2 is electrically connected to the control unit 4 and the second switch element SW2 has its ON/OFF states controlled in accordance with a control signal S4 supplied from the control unit 4.

The particular motor system 5A is connected to a particular bus line B4, which is a DC 200 V bus line. The higher-potential electrical path of the particular bus line B4 is electrically connected to the input/output terminal T211 and the lower-potential electrical path of the particular bus line B4 is connected to GND.

In short, according to this connection, the output voltage value in the charging mode (voltage step-up control mode) of the first power converter circuit 2A corresponds to the voltage value of the DC 100 V bus line B32. The output voltage value in the charging mode (voltage step-up control mode) of the second power converter circuit 2B corresponds to the voltage value of the particular bus line B4. Simply speaking, the first power converter circuit 2A serves as a 48V/100V converter circuit and the second power converter circuit 2B serves as a 100V/200V converter circuit.

In the regenerative power utilization system 1 according to the third variation, the first measuring unit H1 also measures (detects) the voltage between the input/output terminals T111 and T112 to output a first measured value to the control unit 4. The second measuring unit H2 also measures (detects) the voltage between the input/output terminals T211 and T112 to output a second measured value to the control unit 4. The third measuring unit H3 also measures (detects) the voltage between the input/output terminals T113 and T112 to output a third measured value to the control unit 4.

In the third variation, the control unit 4 decides, based on the first measured value, whether the DC 48 V bus line B31 is in the powering prevalent state or the regeneration prevalent state. The control unit 4 decides, based on the second measured value, whether the particular bus line B4 is in the powering prevalent state or the regeneration prevalent state. The control unit 4 determines the control mode according to the combination of these results of decision. Then, the control unit 4 controls the first switch element SW1 and the second switch element SW2 of the first power converter circuit 2A in the control mode thus determined. In the charging mode, the regenerative power on the side including the DC 48 V bus line B31 is stored in the first electrical storage unit 3A. In the discharging mode, the regenerative power is discharged from the first electrical storage unit 3A and used as the powering energy on the side including the DC 48 V bus line B31.

In addition, the control unit 4 also decides based on the third measured value whether the DC 100 V bus line B32 is in the powering prevalent state or the regeneration prevalent state. The control unit 4 decides, based on the second measured value, whether the particular bus line B4 is in the powering prevalent state or the regeneration prevalent state. The control unit 4 determines the control mode according to the combination of these results of decision. Then, the control unit 4 controls the first switch element SW1 and the second switch element SW2 of the second power converter circuit 2B in the control mode thus determined. In the charging mode, the regenerative power on the side including the DC 100 V bus line B32 is stored in the second electrical storage unit 3B. In the discharging mode, the regenerative power is discharged from the second electrical storage unit 3B and used as the powering energy on the side including the DC 100 V bus line B32.

Note that the regenerative power on the side including the particular bus line B4 is stored in both the first electrical storage unit 3A and the second electrical storage unit 3B.

As can be seen from the foregoing description, the third variation, as well as the second variation, makes it easier to apply the regenerative power utilization system 1 to even three types of motor systems 5, thus contributing to improvement on the utilization of regenerative power. Optionally, the regenerative power utilization system 1 is also applicable to even four or more types of motor systems 5 by increasing the number of the power converter circuits 2 provided and connecting the power converter circuit 2 in a similar manner. For example, if a fourth motor system is additionally provided for the configuration of this third variation, then a fourth power converter circuit corresponding to the fourth motor system is additionally provided. In that case, the connection may be adjusted such that the output voltage value of the fourth power converter circuit in the charging mode corresponds to the voltage value of the low-voltage bus lines B3 of the first low-voltage motor system 5B1. After that, as in the third variation described above, the connection may be adjusted such that the output voltage value of the first power converter circuit 2A in the charging mode corresponds to the voltage value of the low-voltage bus lines B3 in the second low-voltage motor system 5B2

### Other Variations

The functions of the regenerative power utilization systems 1 according to the exemplary embodiment and the first variation described above may also be implemented as, for example, a control method, a computer program, or a non-transitory storage medium on which the computer program is stored.

The regenerative power utilization system 1 (among other things, its control unit 4) according to the present disclosure includes a computer system. The computer system may include a processor and a memory as principal hardware components thereof. The computer system performs the functions of the regenerative power utilization system 1 (among other things, its control unit 4) according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment and the first to third variations thereof described above, the plurality of function of the regenerative power utilization system 1 are aggregated together in a single housing. However, this is not an essential configuration for the regenerative power utilization system 1. Alternatively, those constituent elements of the regenerative power utilization system 1 may be distributed in multiple different housings. Conversely, the plurality of functions of the regenerative power utilization system 1 may be aggregated together in a single housing as in the exemplary embodiment and the first to third variations thereof described above.

### Recapitulation

The exemplary embodiment and its variations described above are specific implementations of the following aspects of the present disclosure.

A regenerative power utilization system (1) according to a first aspect is configured to utilize regenerative power generated by at least two types of motor systems (5). The at least two types of motor systems (5) include: a first motor system (51) including one or more first motors (M11); and a second motor system (52) including one or more second motors (M12) having a higher voltage specification than the one or more first motors (M11). The regenerative power utilization system (1) includes a power converter circuit (2) of a voltage step up/down type, an electrical storage device (3), and a control unit (4). The power converter circuit (2) is connected between a first bus line (B1) to supply electrical power to the first motor system (51) and a second bus line (B2) to supply electrical power to the second motor system (52). The power converter circuit (2) includes a plurality of switch elements (SW0) and performs a switching operation on the plurality of switch elements (SW0). The electrical storage device (3) is connected to the power converter circuit (2) either between one side and the power converter circuit (2), or between the other side and the power converter circuit (2). The one side includes the first bus line (B1). The other side includes the second bus line (B2). The control unit (4) controls the plurality of switch elements (SW0) to charge the electrical storage device (3) with the regenerative power. The control unit (4) controls the plurality of switch elements (SW0) such that electrical energy stored in the electrical storage device (3) is used as electrical energy for powering the first motor system (51) when a particular condition is satisfied.

According to this aspect, an electrical storage device (3) is charged with regenerative power generated by a first motor system (51) and a second motor system (52), each of which includes motors (M1) with a different voltage specification from motors (M1) of the other motor system, and the electrical energy stored in the electrical storage device (3) is used as electrical energy for powering the first motor system (51). Consequently, this regenerative power utilization system (1) achieves the advantage of contributing to improvement on the utilization of regenerative power.

In a regenerative power utilization system (1) according to a second aspect, which may be implemented in conjunction with the first aspect, the electrical storage device (3) is connected between the other side, including the second bus line (B2), and the power converter circuit (2). The control unit (4) controls the plurality of switch elements (SW0) to step up voltage of the regenerative power generated by the first motor system (51) and charge the electrical storage device (3) with the regenerative power. The control unit (4) also controls the plurality of switch elements (SW0) to step down the voltage of the electrical energy stored in the electrical storage device (3) and use the electrical energy as the electrical energy for powering the first motor system (51).

This aspect makes it easier to charge the electrical storage device (3) more efficiently with the regenerative power generated by the second motor system (52) with the high voltage specification by using, for example, an electrical storage device (3) with a high breakdown voltage without stepping down the voltage of the regenerative power.

In a regenerative power utilization system (1) according to a third aspect, which may be implemented in conjunction with the first or second aspect, the control unit (4) includes a decider (41) and a determiner (42). The decider (41) decides which of the powering energy generated or the regenerative power generated is larger in quantity on each of the one side including the first bus line (B1) and the other side including the second bus line (B2). The determiner (42) determines, based on a decision made by the decider (41), which of a plurality of control modes is to be selected. The control unit (4) controls the plurality of switch elements (SW0) in the control mode determined to select by the determiner (42). The plurality of control modes includes at least a step-up control mode and a step-down control mode.

This aspect allows the power converter circuit (2) to be controlled more appropriately according to the state of the powering energy and regenerative power on each of the one side including the first bus line (B1) and the other side including the second bus line (B2).

In a regenerative power utilization system (1) according to a fourth aspect, which may be implemented in conjunction with the third aspect, the decider (41) compares a measured value about each of the first bus line (B1) and the second bus line (B2) with a predetermined reference value. Regarding each of the first bus line (B1) and the second bus line (B2), the decider (41) decides, when finding the measured value about a corresponding bus line greater than the predetermined reference value, that the corresponding bus line be in a regeneration prevalent state where the quantity of the regenerative power generated is larger than the quantity of the powering energy generated. Regarding each of the first bus line (B1) and the second bus line (B2), the decider (41) decides, when finding the measured value about a corresponding bus line equal to or less than the predetermined reference value, that the corresponding bus line be in a powering prevalent state where the quantity of the regenerative power generated is smaller than the quantity of the powering energy generated. The measured value is a value about at least one of a current value, a voltage value, a current rise rate, or a voltage rise rate.

This aspect allows for more accurately deciding whether the corresponding bus line of the first bus line (B1) and the second bus line (B2) is in the regeneration prevalent state or in the powering prevalent state.

In a regenerative power utilization system (1) according to a fifth aspect, which may be implemented in conjunction with the fourth aspect, the control unit (4) controls the plurality of switch elements (SW0) in the following situation. The control unit (4) increases voltage on a side, including the other bus line, of the one side and the other side, to allow a current to flow from the electrical storage device (3) to the side including the other bus line in the powering prevalent state. The situation herein refers to a situation where the decision made by the decider (41) indicates that one bus line selected from the group consisting of the first bus line (B1) and the second bus line (B2) is in the regeneration prevalent state and the other bus line selected from the group consisting of the first bus line (B1) and the second bus line (B2) is in the powering prevalent state.

This aspect allows the power converter circuit (2) to be controlled more appropriately when one of the first bus line (B1) or the second bus line (B2) is in the regeneration prevalent state and the other bus line is in the powering prevalent state.

In a regenerative power utilization system (1) according to a sixth aspect, which may be implemented in conjunction with the fourth or fifth aspect, the control unit (4) controls the plurality of switch elements (SW0) in the following situation. The control unit (4) increases voltage on the other side including the second bus line (B2) to allow a current to flow from the electrical storage device (3) to the other side including the second bus line (B2). The situation herein refers to a situation where the decision made by the decider (41) indicates that the first bus line (B1) and the second bus line (B2) are both in the regeneration prevalent state.

This aspect allows the power converter circuit (2) to be controlled more appropriately when both the first bus line (B1) and the second bus line (B2) are in the regeneration prevalent state.

In a regenerative power utilization system (1) according to a seventh aspect, which may be implemented in conjunction with any one of the fourth to sixth aspects, the control unit (4) suspends the switching operation in the following situation to prevent a current from flowing from the electrical storage device (3) to the first bus line (B1) or the second bus line (B2). The situation herein refers to a situation where the decision made by the decider (41) indicates that the first bus line (B1) and the second bus line (B2) are both in the powering prevalent state.

This aspect allows the power converter circuit (2) to be controlled more appropriately when both the first bus line (B1) and the second bus line (B2) are in the powering prevalent state.

In a regenerative power utilization system (1) according to an eighth aspect, which may be implemented in conjunction with any one of the third to seventh aspects, the control unit (4) uses, in accordance with a result of determination by the determiner (42), a voltage value, higher than a current voltage value, as a target value with respect to one bus line selected from the group consisting of the first bus line (B1) and the second bus line (B2) which is to be supplied with a current from the regenerative power utilization system (1). Then, the control unit (4) adjusts a duty about switching control of the plurality of switch elements (SW0).

This aspect allows the power converter circuit (2) to perform voltage step-up and step-down control more appropriately.

A regenerative power utilization system (1) according to a ninth aspect, which may be implemented in conjunction with any one of the first to eighth aspects, further includes a capacitor (C1) disposed between the one side including the first bus line (B1) and the power converter circuit (2). The first bus line (B1) includes a first electrical path (B11) on a higher potential side and a second electrical path (B12) on a lower potential side. A first terminal of the capacitor (C1) is electrically connected to the first electrical path (B11) and a second terminal of the capacitor (C1) is electrically connected to the second electrical path (B12).

This aspect allows for reducing, by providing the capacitor (C1), the voltage rise rate as a transient response of the regenerative power utilization system (1) when the regenerative power increases steeply on the one side including the first bus line (B1).

A regenerative power utilization system (1) according to a tenth aspect, which may be implemented in conjunction with any one of the first to ninth aspects, further includes a power consumption unit (6). The power consumption unit (6) includes: a particular switch element (61), of which ON/OFF states are subjected to switching control by the control unit (4); and a resistor (62) connected to the particular switch element (61) in series. The power consumption unit (6) is disposed between the other side including the second bus line (B2) and the power converter circuit (2). The control unit (4) performs ON-state control on the particular switch element (61) to cause the resistor (62) to consume extra power generated on the other side including the second bus line (B2).

This aspect allows, if any regenerative power exceeding a permissible value (i.e., excessive power) is generated on the other side including the second bus line (B2), the regenerative power to be consumed by the resistor (62). In other words, this aspect contributes to increasing permissible power consumption about the regenerative power in the regenerative power utilization system (1). Consequently, this contributes to increasing stability about the regenerative power on the second bus line (B2).

In a regenerative power utilization system (1) according to an eleventh aspect, which may be implemented in conjunction with any one of the first to tenth aspects, the at least two types of motor systems (5) include three or more types of motor systems (5). Each of the three or more types of motor systems (5) includes one or more motors (M1). The one or more motors (M1) included in each of the three or more types of motor systems (5) have a different voltage specification from the one or more motors (M1) included in any other one of the three or more types of motor systems (5). The three or more types of motor systems (5) include a particular motor system (5A) including the one or more motors (M1) having the highest voltage specification and a plurality of low-voltage motor systems (5B) other than the particular motor system (5A). Each of the plurality of low-voltage motor systems (5B) is defined as the first motor system (51). The particular motor system (5A) is defined as the second motor system (52). The regenerative power utilization system (1) includes a plurality of the power converter circuits (2). The plurality of the power converter circuits (2) are connected to a plurality of low-voltage bus lines (B3) respectively corresponding to the plurality of low-voltage motor systems (5B) and a particular bus line (B4) corresponding to the particular motor system (5A) to satisfy the following requirement. Specifically, an output voltage value after voltage of the regenerative power, supplied from each of the plurality of low-voltage bus lines (B3), has been stepped up should agree with a voltage value on the particular bus line (B4).

This aspect makes it easier to apply the regenerative power utilization system (1) to even three or more types of motor systems (5), thus contributing to improvement on the utilization of regenerative power.

In a regenerative power utilization system (1) according to a twelfth aspect, which may be implemented in conjunction with any one of the first to tenth aspects, the at least two types of motor systems (5) include three or more types of motor systems (5). Each of the three or more types of motor systems (5) includes one or more motors (M1). The one or more motors (M1) included in each of the three or more types of motor systems (5) have a different voltage specification from the one or more motors (M1) included in any other one of the three or more types of motor systems (5). The three or more types of motor systems (5) include a particular motor system (5A) including the one or more motors (M1) having the highest voltage specification and a plurality of low-voltage motor systems (5B) other than the particular motor system (5A). Each of the plurality of low-voltage motor systems (5B) is defined as the first motor system (51). The particular motor system (5A) is defined as the second motor system (52). The regenerative power utilization system (1) includes a plurality of the power converter circuits (2). The plurality of the power converter circuits (2) are connected to a plurality of low-voltage bus lines (B3) respectively corresponding to the plurality of low-voltage motor systems (5B) and a particular bus line (B4) corresponding to the particular motor system (5A) to satisfy the following two requirements. One requirement is that an output voltage value after voltage of the regenerative power, supplied from a first low-voltage bus line (DC 48 V bus line B31) belonging to the plurality of low-voltage bus lines (B3), has been stepped up should agree with a voltage value on a second low-voltage bus line (DC 100 V bus line B32) belonging to the plurality of low-voltage bus lines (B3). The other requirement is that an output voltage value after the voltage of the regenerative power, supplied from the second low-voltage bus line (DC 100 V bus line B32), has been stepped up should agree with a voltage value on the particular bus line (B4).

This aspect makes it easier to apply the regenerative power utilization system (1) to even three or more types of motor systems (5), thus contributing to improvement on the utilization of regenerative power.

A control method according to a thirteenth aspect is designed to utilize regenerative power generated by at least two types of motor systems (5). The at least two types of motor systems (5) include: a first motor system (51) including one or more first motors (M11); and a second motor system (52) including one or more second motors (M12) having a higher voltage specification than the one or more first motors (M11). The control method includes a first control step and a second control step. The first control step includes controlling a plurality of switch elements (SW0) in a power converter circuit (2) of a voltage step up/down type to charge an electrical storage device (3) with the regenerative power. The power converter circuit (2) includes the plurality of switch elements (SW0) and performs a switching operation on the plurality of switch elements (SW0). The power converter circuit (2) is connected between a first bus line (B1) to supply electrical power to the first motor system (51) and a second bus line (B2) to supply electrical power to the second motor system (52). The electrical storage device (3) is connected to the power converter circuit (2) either between one side and the power converter circuit (2), or between the other side and the power converter circuit (2). The one side includes the first bus line (B1). The other side includes the second bus line (B2). The second control step includes controlling the plurality of switch elements (SW0) such that electrical energy stored in the electrical storage device (3) is used as electrical energy for powering the first motor system (51) when a particular condition is satisfied.

This aspect may provide a control method contributing to improvement on the utilization of regenerative power.

A program according to a fourteenth aspect is designed to cause one or more processors to perform the control method according to the thirteenth aspect.

This aspect may provide a function contributing to improvement on the utilization of regenerative power.

Note that the constituent elements according to the second to twelfth aspects are not essential constituent elements for the regenerative power utilization system (1) but may be omitted as appropriate.

### REFERENCE SIGNS LIST

1 Regenerative Power Utilization System
2 Power Converter Circuit
3 Electrical Storage Device
4 Control Unit
41 Decider
42 Determiner
5 Motor System
51 First Motor System
52 Second Motor System
5A Particular Motor System
5B Low-Voltage Motor System
6 Power Consumption Unit
61 Particular Switch Element
62 Resistor
B1 First Bus Line
B11 First Electrical Path
B12 Second Electrical Path
B2 Second Bus Line
B3 Low-Voltage Bus Line
B31 DC 48 V Bus Line (First Low-Voltage Bus Line)
B32 DC 100 V Bus Line (Second Low-Voltage Bus Line)
B4 Particular Bus Line
C1 Capacitor
G1 Power Conversion Unit
M1 Motor
M11 First Motor
SW0 Switch Element

1. A regenerative power utilization system configured to utilize regenerative power generated by at least two types of motor systems, the at least two types of motor systems including: a first motor system including one or more first motors; and a second motor system including one or more second motors having a higher voltage specification than the one or more first motors, the regenerative power utilization system comprising:
a power converter circuit of a voltage step up/down type, the power converter circuit being connected between a first bus line configured to supply electrical power to the first motor system and a second bus line configured to supply electrical power to the second motor system, the power converter circuit including a plurality of switch elements and configured to perform a switching operation on the plurality of switch elements;
an electrical storage device connected to the power converter circuit either between one side and the power converter circuit, or between the other side and the power converter circuit, the one side including the first bus line, the other side including the second bus line; and
a control unit configured to control the plurality of switch elements to charge the electrical storage device with the regenerative power,
the control unit being configured to control the plurality of switch elements such that electrical energy stored in the electrical storage device is used as electrical energy for powering the first motor system when a particular condition is satisfied.

2. The regenerative power utilization system of claim 1, wherein
the electrical storage device is connected between the other side and the power converter circuit, the other side including the second bus line, and
the control unit is configured to:
control the plurality of switch elements to step up voltage of the regenerative power generated by the first motor system and charge the electrical storage device with the regenerative power; and
control the plurality of switch elements to step down the voltage of the electrical energy stored in the electrical storage device and use the electrical energy as the electrical energy for powering the first motor system.

3. The regenerative power utilization system of claim 1, wherein
the control unit includes:
a decider configured to decide which of the powering energy generated or the regenerative power generated is larger in quantity on each of the one side including the first bus line and the other side including the second bus line; and
a determiner configured to determine, based on a decision made by the decider, which of a plurality of control modes is to be selected,
the control unit is configured to control the plurality of switch elements in a control mode determined to select by the determiner, and
the plurality of control modes includes at least a step-up control mode and a step-down control mode.

4. The regenerative power utilization system of claim 3, wherein
the decider is configured to:
compare a measured value about each of the first bus line and the second bus line with a predetermined reference value;
regarding each of the first bus line and the second bus line, decide, when finding the measured value about a corresponding bus line greater than the predetermined reference value, that the corresponding bus line be in a regeneration prevalent state where the quantity of the regenerative power generated is larger than the quantity of the powering energy generated; and
regarding each of the first bus line and the second bus line, decide, when finding the measured value about a corresponding bus line equal to or less than the predetermined reference value, that the corresponding bus line be in a powering prevalent state where the quantity of the regenerative power generated is smaller than the quantity of the powering energy generated; and
the measured value is a value about at least one of a current value, a voltage value, a current rise rate, or a voltage rise rate.

5. The regenerative power utilization system of claim 4, wherein
the control unit is configured to, when the decision made by the decider indicates that one bus line selected from the group consisting of the first bus line and the second bus line is in the regeneration prevalent state and the other bus line selected from the group consisting of the first bus line and the second bus line is in the powering prevalent state, control the plurality of switch elements to increase voltage on a side, including the other bus line, of the one side and the other side, to allow a current to flow from the electrical storage device to the side including the other bus line in the powering prevalent state.

6. The regenerative power utilization system of claim 4, wherein
the control unit is configured to, when the decision made by the decider indicates that the first bus line and the second bus line are both in the regeneration prevalent state, control the plurality of switch elements to increase voltage on the other side including the second bus line to allow a current to flow from the electrical storage device to the other side including the second bus line.

7. The regenerative power utilization system of claim 4, wherein
the control unit is configured to, when the decision made by the decider indicates that the first bus line and the second bus line are both in the powering prevalent state, suspend the switching operation to prevent a current from flowing from the electrical storage device to the first bus line or the second bus line.

8. The regenerative power utilization system of claim 3, wherein
the control unit is configured to adjust, in accordance with a result of determination made by the determiner, a duty about switching control of the plurality of switch elements with respect to one bus line selected from the group consisting of the first bus line and the second bus line which is to be supplied with a current from the regenerative power utilization system by using a voltage value, higher than a current voltage value, as a target value.

9. The regenerative power utilization system of claim 1, further comprising a capacitor disposed between the one side including the first bus line and the power converter circuit, wherein
the first bus line includes a first electrical path on a higher potential side and a second electrical path on a lower potential side, and
a first terminal of the capacitor is electrically connected to the first electrical path and a second terminal of the capacitor is electrically connected to the second electrical path.

10. The regenerative power utilization system of claim 1, further comprising a power consumption unit including: a particular switch element, of which ON/OFF states are subjected to switching control by the control unit; and a resistor connected to the particular switch element in series, wherein
the power consumption unit is disposed between the other side including the second bus line and the power converter circuit, and
the control unit is configured to perform ON-state control on the particular switch element to cause the resistor to consume extra power generated on the other side including the second bus line.

11. The regenerative power utilization system of claim 1, wherein
the at least two types of motor systems include three or more types of motor systems, each of the three or more types of motor systems including one or more motors, the one or more motors included in each of the three or more types of motor systems having a different voltage specification from the one or more motors included in any other one of the three or more types of motor systems,
the three or more types of motor systems including a particular motor system including the one or more motors having the highest voltage specification and a plurality of low-voltage motor systems other than the particular motor system,
each of the plurality of low-voltage motor systems is defined as the first motor system,
the particular motor system is defined as the second motor system,
the regenerative power utilization system includes a plurality of the power converter circuits, and
the plurality of the power converter circuits are connected to a plurality of low-voltage bus lines respectively corresponding to the plurality of low-voltage motor systems and a particular bus line corresponding to the particular motor system such that an output voltage value after voltage of the regenerative power, supplied from each of the plurality of low-voltage bus lines, has been stepped up agrees with a voltage value on the particular bus line.

12. The regenerative power utilization system of claim 1, wherein
the at least two types of motor systems include three or more types of motor systems, each of the three or more types of motor systems including one or more motors, the one or more motors included in each of the three or more types of motor systems having a different voltage specification from the one or more motors included in any other one of the three or more types of motor systems,
the three or more types of motor systems including a particular motor system including the one or more motors having the highest voltage specification and a plurality of low-voltage motor systems other than the particular motor system,
each of the plurality of low-voltage motor systems is defined as the first motor system,
the particular motor system is defined as the second motor system,
the regenerative power utilization system includes a plurality of the power converter circuits, and
the plurality of the power converter circuits are connected to a plurality of low-voltage bus lines respectively corresponding to the plurality of low-voltage motor systems and a particular bus line corresponding to the particular motor system such that an output voltage value after voltage of the regenerative power, supplied from a first low-voltage bus line belonging to the plurality of low-voltage bus lines, has been stepped up agrees with a voltage value on a second low-voltage bus line belonging to the plurality of low-voltage bus lines and that an output voltage value after the voltage of the regenerative power, supplied from the second low-voltage bus line, has been stepped up agrees with a voltage value on the particular bus line.

13. A control method designed to utilize regenerative power generated by at least two types of motor systems, the at least two types of motor systems including: a first motor system including one or more first motors; and a second motor system including one or more second motors having a higher voltage specification than the one or more first motors, the control method comprising:
a first control step including controlling a plurality of switch elements in a power converter circuit of a voltage step up/down type to charge an electrical storage device with the regenerative power, the power converter circuit being connected between a first bus line configured to supply electrical power to the first motor system and a second bus line configured to supply electrical power to the second motor system, the power converter circuit including the plurality of switch elements and configured to perform a switching operation on the plurality of switch elements, the electrical storage device being connected to the power converter circuit either between one side and the power converter circuit, or between the other side and the power converter circuit, the one side including the first bus line, the other side including the second bus line; and
a second control step including controlling the plurality of switch elements such that electrical energy stored in the electrical storage device is used as electrical energy for powering the first motor system when a particular condition is satisfied.

14. A non-transitory computer-readable tangible recording medium storing a program designed to cause one or more processors to perform the control method of claim 13.
